(19) United States
(12) Patent Application Publication
(10) Pub. No.: US 2009/0046757 A1
(43) Pub. Date: Feb. 19, 2009

(54) Laser irradiation apparatus, laser irradiation method, and manufacturing method of semiconductor device

(75) Inventors: Hidekazu Miyairi, Isehara (JP); Junpei Momo, Sagamihara (JP); Fumito Isaka, Zama (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 12/222,258

(22) Filed: Aug. 6, 2008

(30) Foreign Application Priority Data
Aug. 16, 2007 (JP) 2007-212046

(51) Int. Cl. H01S 3/108; G21G 5/00

(52) U.S. Cl. 372/101; 250/492.1

(57) ABSTRACT

An object is to provide a laser irradiation apparatus and a laser irradiation method with which positions of crystal grain boundaries generated at the time of laser crystallization can be controlled. Laser light emitted from a laser 101 is modulated into laser light having intensity distribution along a long-axis direction through a phase shift mask 103 and is transferred to an amorphous semiconductor film provided over an insulating substrate by a cylindrical lens 104 and a lens 105. The amorphous semiconductor film is crystallized by being scanned with the laser light.

### BACKGROUND OF THE INVENTION

1. Field of the Invention

The present invention relates to a laser irradiation apparatus and a laser irradiation method. The present invention also relates to a manufacturing method of a semiconductor device using the laser irradiation apparatus.

2. Description of the Related Art

In recent years, a laser crystallization technique, by which an amorphous semiconductor film formed over a glass substrate is irradiated with laser light (also referred to as a laser beam) to form a semiconductor film having a crystalline structure (hereinafter, a crystalline semiconductor film), has been widely researched, and a large number of proposals have been announced. A semiconductor element manufactured using a crystalline semiconductor film has higher mobility than that manufactured using an amorphous semiconductor film. As a result, an element manufactured using a crystalline semiconductor film can be used in, for example, an active-matrix liquid crystal display device, an organic EL display device, or the like.

Crystallization methods include a thermal annealing method using an annealing furnace and a rapid thermal annealing (RTA) method as well as laser crystallization. However, when laser crystallization is employed, a semiconductor film can be crystallized by locally absorbing heat; thus, the process can be performed at relatively low temperature (generally, 600° C. or lower). Therefore, by use of laser crystallization, a substance having low melting point, such as glass or plastic, can be used for a substrate, and by use of a glass substrate which is inexpensive and can be easily processed into a large-area substrate, production efficiency can be increased significantly.

Lasers are roughly classified into two types, pulsed lasers and continuous wave lasers, according to their modes of operation. As pulsed laser crystallization, there is a crystallization method with an excimer laser. The wavelength of excimer laser light is in the ultraviolet range, and silicon has high absorptance for the excimer laser light. Therefore, by use of an excimer laser, heat can be selectively applied to silicon. For example, when an excimer laser is used, a rectangular laser beam of about 10 mm×30 mm which is emitted from a laser is shaped using an optical system into a linear beam spot of several hundreds of micrometers in width and 300 mm or more in length, with which silicon over a substrate is irradiated. Here, “linear” does not mean a “line” in a strict sense, and being a rectangle or an ellipse with a high aspect ratio is referred to as “linear”. Annealing is performed by irradiation of silicon over a substrate with the linearly processed beam spot while being scanned relatively, thereby obtaining a crystalline silicon film. When a direction in which silicon is scanned with the beam spot is set perpendicular to a longitudinal (long-axis) direction of the beam spot, high productivity is obtained.

As another laser crystallization method, there is a crystallization method using a pulsed laser having a high repetition rate of 10 MHz or more or using a continuous-wave laser (hereinafter, referred to as a CW laser). Abeam emitted from such a laser is shaped into a linear beam spot, and a semiconductor film is irradiated with the linear beam spot while being scanned, thereby obtaining a crystalline silicon film. By use of this method, it is possible to form a crystalline silicon film having a region of a crystal with a significantly large grain size (hereinafter referred to as a large grain crystal) as compared to a crystal obtained by irradiation with excimer laser light (for example, refer to Reference 1: Japanese Published Patent Application No. 2005-191546). By use of this large grain crystal for a channel region of a thin film transistor (hereinafter also referred to as a TFT), because crystal grains which are elongated along a channel direction and are larger than crystal grains for which an excimer laser is used can be obtained, carrier scattering due to crystal grain boundaries can be reduced, and an electrical barrier to carriers such as electrons and holes is lowered. As a result, a TFT with a field-effect mobility of 120 cm² Vs or more can be manufactured.

### SUMMARY OF THE INVENTION

Crystallization using a pulsed laser having a repetition rate of 10 MHz or more or using a CW laser is performed in such a manner that laser light emitted from a laser is shaped using an optical system into a linear shape and a semiconductor film is irradiated therewith while being scanned at a constant rate of about 100 mm/sec to 2000 mm/sec. In general, as shown in FIG. 6B, laser irradiation is performed in a state where a semiconductor film 30 is formed over a substrate 10 and a base insulating film 20. In this case, the resulting crystal has, as shown in FIG. 6A, a close relationship with an energy density of the laser light and is changed to a microcrystal, a small grain crystal, and a large grain crystal as the energy density of the laser light is increased.

The term “small grain crystal” here refers to one that is similar to a crystal formed when irradiation with excimer laser light is performed. When a semiconductor film is irradiated with excimer laser light, only a superficial layer of the semiconductor film is partially melted and numerous crystal nuclei are randomly generated at the interface between the semiconductor film and a base insulating film. Then, crystals grow in a direction that the crystal nuclei are cooled and solidified, that is, in a direction from the interface between the semiconductor film and the base insulating film toward the surface of the semiconductor film. Thus, numerous relatively small crystals are formed.

Also through the crystallization using a CW laser or using a pulsed laser having a repetition rate of 10 MHz or more, there is a portion where small grain crystals are formed as in a portion which is irradiated with an end portion of a laser beam. It can be understood that this is a result of the fact that the semiconductor film is partially melted without being supplied with sufficient heat for the semiconductor film to be melted completely.

When crystallization is performed under a condition that the semiconductor film is completely melted, that is, when crystallization is performed by irradiation of the semiconductor film with a laser beam having an energy equal to or higher than E₃ in FIG. 6A, large grain crystals are formed. In this case, in the semiconductor film being completely melted, numerous crystal nuclei are generated, and each crystal nucleus grows into a crystal in a laser beam scanning direction as a solid-liquid interface is moved. Because the crystal nuclei are generated at random positions, the crystal nuclei are distributed unevenly. In addition, because crystal growth is terminated at a position where crystal grains meet each other, crystal grain boundaries are generated at random positions.

However, in order to form an advanced or large-scale functional circuit over a substrate, it is necessary for a semiconductor element, which is formed using a crystalline semiconductor film, to have less variation as well as to have high mobility, and crystal grain boundaries generated at random are one of causes of variation in characteristics of a semiconductor element.

In view of the foregoing description, it is an object of the present invention to provide a laser irradiation apparatus and a laser irradiation method with which the positions of crystal grain boundaries generated at the time of laser crystallization can be controlled. It is another object of the present invention to provide a manufacturing method of a semiconductor device which has excellent electrical characteristics and less variation in electrical characteristics between semiconductor elements.

One aspect of the present invention is a laser irradiation apparatus including a laser configured to emit a pulsed laser light having a repetition rate of 10 MHz or more or a laser configured to emit a continuous-wave laser light, a phase shift mask configured to diffract laser light to change intensity distribution along a long-axis direction of the laser light, a cylindrical lens configured to form an image of the laser light diffracted by the phase shift mask on an irradiation surface, and a lens configured to converge the laser light diffracted by the phase shift mask on the irradiation surface.

Another aspect of the present invention is a laser irradiation method by which laser light emitted from a laser configured to emit a pulsed laser light having a repetition rate of 10 MHz or more or from a laser configured to emit a continuous-wave laser light is modulated into laser light having intensity distribution along a long-axis direction of the laser light through a phase shift mask and is transferred to an irradiation surface through a cylindrical lens and a lens.

Another aspect of the present invention is a manufacturing method of a semiconductor device, by which an amorphous semiconductor film provided over an insulating substrate is crystallized by being irradiated with laser light emitted from the above-mentioned laser irradiation apparatus of the present invention while being scanned with the laser light to crystallize the amorphous semiconductor film.

According to the present invention, the position at which a crystal grain boundary is generated can be controlled in laser crystallization. In addition, a crystal in which the position at which a grain boundary is generated is controlled can be manufactured to have a large area with a high yield.

Furthermore, according to the present invention, crystal growth can be controlled in one direction along a laser light scanning direction. Therefore, the width of a crystal grain can be increased compared to that of a conventional crystal obtained with a pulsed laser having a repetition rate of 10 MHz or more or with a CW laser, and the widths of crystal grains can be made to be uniform; thus, carrier scattering can be reduced significantly. Accordingly, in a semiconductor element having a crystalline semiconductor film, the mobility of a semiconductor layer can be increased.

The laser irradiation apparatus of the present invention has a phase shift mask and forms an image of and converges (transfers) light diffracted by the phase shift mask onto an irradiation surface using a cylindrical lens and a lens. Accordingly, a sufficient workspace can be made between the phase shift mask and the irradiation surface, and operation efficiency is improved.

Moreover, according to the present invention, the mobility of a semiconductor layer of a semiconductor element is increased. Therefore, a semiconductor element having favorable electrical characteristics can be manufactured.

### BRIEF DESCRIPTION OF THE DRAWINGS

FIG. 1 is a diagram showing an example of a laser irradiation apparatus of the present invention.

FIGS. 2A and 2B are diagrams showing an example of an optical system which is included in a laser irradiation apparatus of the present invention.

FIGS. 3A to 3D are diagrams showing an example of an optical system which is included in a laser irradiation apparatus of the present invention.

FIGS. 4A to 4C are diagrams illustrating a manufacturing method of a semiconductor device of the present invention.

FIGS. 5A to 5C are diagrams illustrating a manufacturing method of a semiconductor device of the present invention.

FIGS. 6A and 6B are diagrams showing a relationship between the intensity of laser light and the state of a semiconductor film irradiated with the laser light.

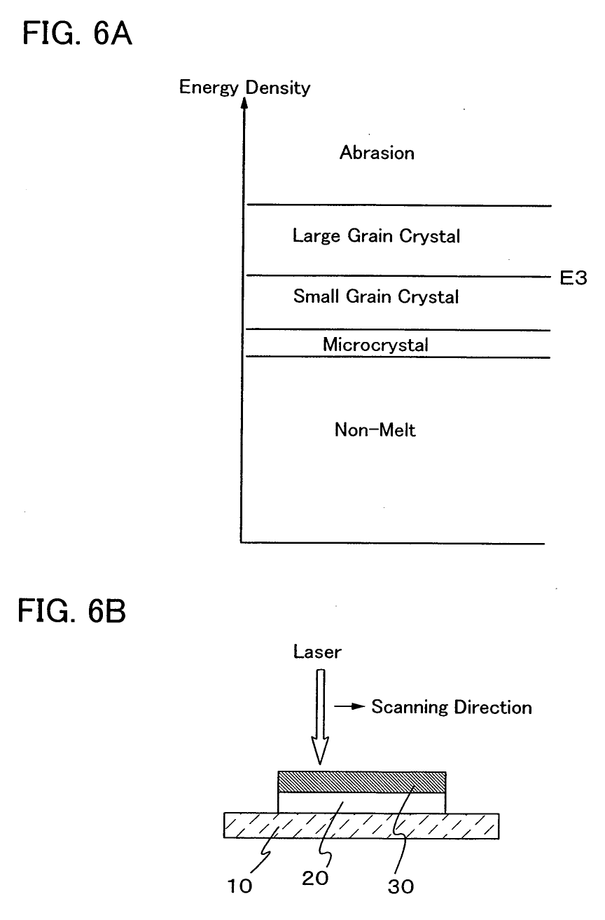

FIGS. 7A to 7C are diagrams illustrating a manufacturing method of a TFT to which the present invention is applied.

FIG. 8 is a block diagram showing an example of a semiconductor device of the present invention.

FIG. 9 is a cross-sectional view showing an example of a semiconductor device of the present invention.

FIG. 10 is a perspective view showing an example of a semiconductor device of the present invention.

FIGS. 11A to 11C are a top view and cross-sectional views showing examples of a semiconductor device of the present invention.

FIGS. 12A to 12D are diagrams each illustrating an antenna which is applicable to a semiconductor device of the present invention.

FIGS. 13A to 13C are a block diagram showing an example of a semiconductor device of the present invention and diagrams showing examples of modes of application.

FIGS. 14A to 14H are diagrams each showing an example of application of a semiconductor device of the present invention.

FIGS. 15A and 15B are diagrams each showing intensity distribution of laser light transmitted through an optical system of a laser irradiation apparatus of the present invention.

FIGS. 16A and 16B are diagrams each showing an optical path in an optical system of a laser irradiation apparatus of the present invention.

FIGS. 17A to 17F are diagrams illustrating disposition of a phase shift mask which is included in a laser irradiation apparatus of the present invention.

FIGS. 18A to 18G are diagrams showing measurement images of a crystalline semiconductor film manufactured using a laser irradiation apparatus of the present invention. FIGS. 18A and 18B are optical micrographs, FIGS. 18C and 18D are EBSP measurement images, and FIGS. 18E and 18F are AFM measurement images.

FIG. 19 is a diagram showing an example of an optical system which is included in a laser irradiation apparatus of the present invention.

FIGS. 20A to 20C are diagrams showing optical micrographs of a crystalline semiconductor film manufactured using a laser irradiation apparatus of the present invention.

FIGS. 21A and 21B are diagrams showing results of EBSP measurement of a crystalline semiconductor film manufactured using a laser irradiation apparatus of the present invention.

### DETAILED DESCRIPTION OF THE INVENTION

Embodiment modes and embodiments will be hereinafter described with reference to the drawings. However, the present invention can be carried out in many different modes, and it is easily understood by those skilled in the art that the modes and details of the present invention can be modified in various ways without departing from the spirit and scope thereof. Therefore, the present invention should not be interpreted as being limited to the following description in the embodiment modes and embodiments.

### Embodiment Mode 1

In this embodiment mode, a laser irradiation apparatus of the present invention and a process for forming a crystalline semiconductor film using the laser irradiation apparatus are described.

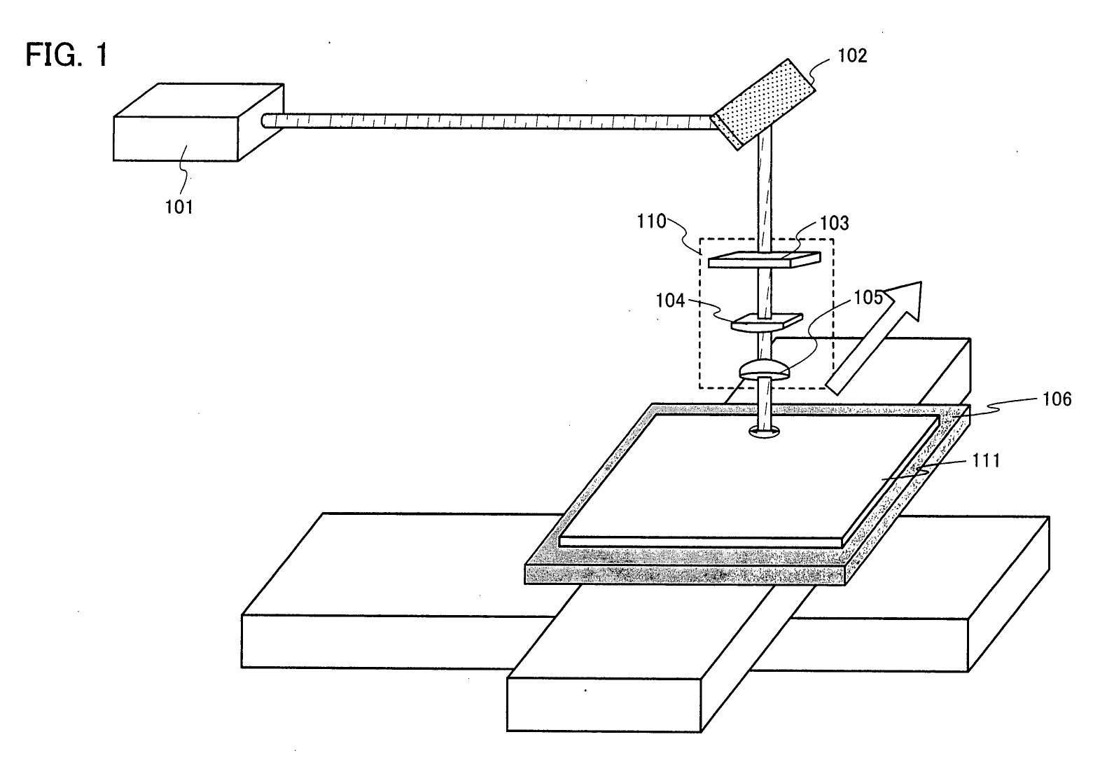

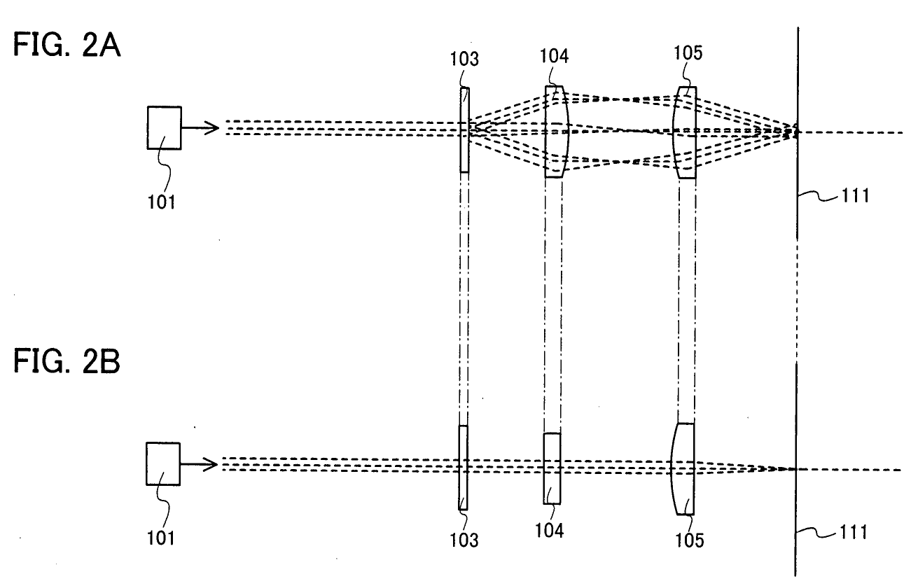

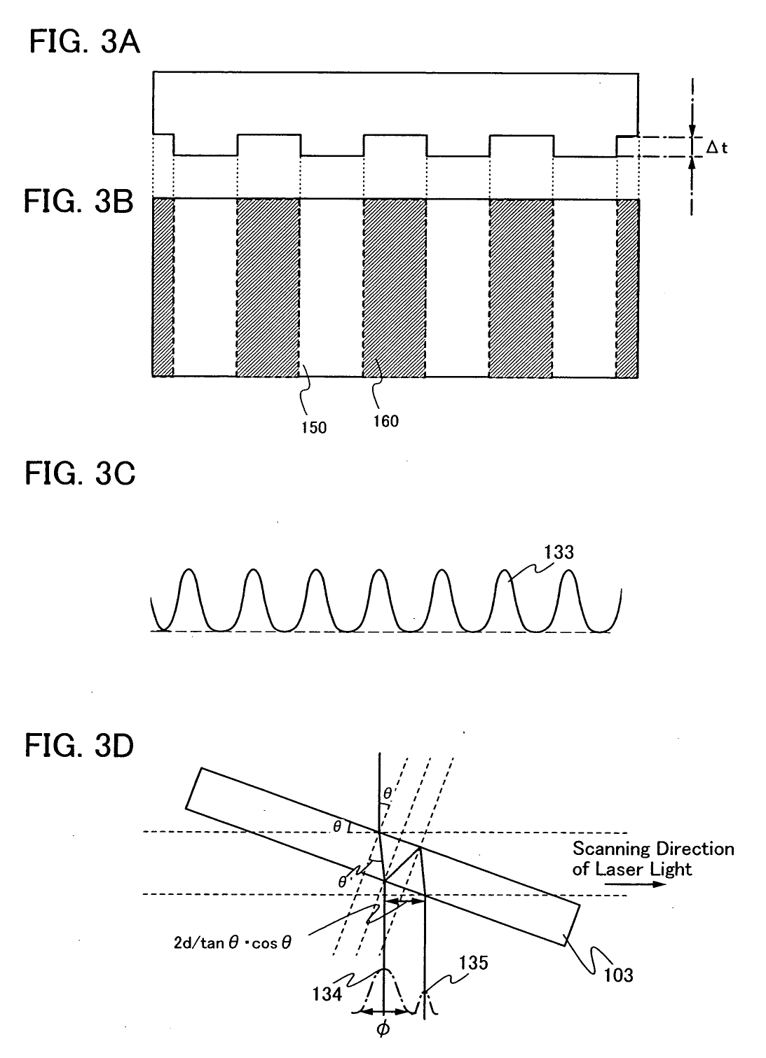

First, a laser irradiation apparatus used for crystallization of a semiconductor layer is described with reference to FIG. 1, FIGS. 2A and 2B, and FIGS. 3A to 3D. A laser irradiation apparatus of the present invention has a laser 101, a mirror 102, an optical system 110, and a stage 106. Note that, in this embodiment mode, the optical system 110 includes a phase shift mask 103, a cylindrical lens 104, and a lens 105 (FIG. 1). However, the present invention is not limited to this structure. For example, between the laser 101 and the cylindrical lens 104, an attenuator for adjusting optical intensity of laser light emitted may be provided. The mirror 102 does not necessarily need to be provided.

As the laser 101, for example, a CW laser which emits a laser beam, which is converted into a second harmonic by using a nonlinear crystal, can be used. Here, a second harmonic (having a wavelength of 532 nm) of a Nd:YVO₄ laser is used. The wavelength of laser light does not need to be particularly limited to a second harmonic, but a second harmonic is superior in energy efficiency to a higher-order harmonic.

In addition, the laser 101 is not limited to a YVO₄ laser, and another CW laser, a pulsed laser having a repetition rate of 10 MHz or more, or the like can be used. For example, as a gas laser, an Ar laser, a Kr laser, a CO₂ laser, or the like can be used, and as a solid-state laser, a YAG laser, a YLF laser, a YAlO₃ laser, a GdVO₄ laser, an alexandrite laser, a Ti:sapphire laser, a Y₂O₃ laser, or the like can be used. Furthermore, a YAG laser, a Y₂O₃ laser, a GdVO₄ laser, or a YVO₄ laser may be a ceramic laser. As a metal vapor laser, a helium cadmium laser or the like can be used. Alternatively, a disk laser may be used. A feature of a disk laser is to have high cooling efficiency, that is, high energy efficiency and high beam quality because its laser medium has a disk shape.

Note that a pulsed laser having a repetition rate of 10 MHz or more is referred to as a quasi-CW laser. A quasi-CW laser can keep a portion irradiated with laser light in a completely melted state, like a CW laser. Thus, a solid-liquid interface can be moved in a semiconductor film by scanning with laser light.

It is preferable that the laser 101 emit a laser beam by oscillating in a TEM₀₀ mode (a single transverse mode) so that a linear beam spot obtained at an irradiation surface 111 can have higher uniformity of energy.

Here, an example of the optical system 110 of the laser irradiation apparatus shown in FIG. 1 is described with reference to FIGS. 2A and 2B. In this embodiment mode, the optical system 110 has the phase shift mask 103, the cylindrical lens 104, and the lens 105 in this order in a traveling direction of laser light. Note that FIG. 2A shows a top view of the optical system 110, and FIG. 2B shows a side view of the optical system 110.

The phase shift mask 103 has projections and depressions, which are arranged in a stripe pattern and intersect with a long-axis direction of laser light, and is used to periodically modulate optical intensity of laser light spatially in the long-axis direction of laser light. The phase of laser light transmitted through the phase shift mask 103 is modulated and partial destructive interference is caused due to the depressions and projections arranged in a stripe pattern of the phase shift mask 103; thus, the laser light can be modulated into that which has periodic intensity. Here, the depressions and projections are provided such that the phase difference between each of the depressions and projections that are adjacent is 180°. Laser light transmitted through the phase shift mask 103 has a plurality of periodic intensity peaks along a long-axis direction.

The cylindrical lens 104 is not particularly limited, but it is particularly preferable that an aspheric cylindrical lens be used as the cylindrical lens 104 because aberration of laser light transmitted can be suppressed and defocus can be reduced by use of an aspheric cylindrical lens. Similarly, the lens 105 is not particularly limited, but it is particularly preferable that an aspheric lens be used because aberration of laser light transmitted can be suppressed and defocus can be reduced by use of an aspheric lens.

Laser light emitted from the laser 101 is first transmitted through the phase shift mask 103 and diffracted along a long-axis direction to change intensity distribution so that the stripe pattern is reflected in intensity distribution along a long-axis direction. Next, an image of the laser light diffracted by the phase shift mask 103 is formed on the irradiation surface 111 by the cylindrical lens 104. At this time, the laser light diffracted by the phase shift mask 103 is converged by the lens 105 (FIG. 2A).

Note that, here, when the focal length of the cylindrical lens 104 is fₐ, it is preferable that the distance between the phase shift mask 103 and the cylindrical lens 104 be fₐ and the distance between the cylindrical lens 104 and the lens 105 be 2fₐ. In addition, when the focal length of the lens 105 is f_{b}, it is preferable that the distance between the lens 105 and the irradiation surface 111 be f_{b}.

As for a short-axis direction, the laser light emitted from the laser 101 is transmitted through the phase shift mask 103 and the cylindrical lens 104 without any change in shape and is incident on the lens 105. Next, the laser light is converged along a short-axis direction by the lens 105 and an image thereof is then formed on the irradiation surface 111 (FIG. 2B). That is, the laser irradiation apparatus of the present invention forms an image of and converges laser light having intensity distribution in a long-axis direction caused by the phase shift mask 103 in a long-axis direction and also converges laser light in a short-axis direction, with the use of the optical system 110, thereby being capable of forming a desired linear beam spot on the irradiation surface 111. In this embodiment mode, a linear beam spot has, for example, a length of about 250 μm and a width of about 5 μm to 10 μm.

FIGS. 3A to 3D are schematic diagrams of the phase shift mask 103 used in the present invention. FIG. 3A shows a side view of the phase shift mask 103, and FIG. 3B shows a top view of the phase shift mask 103. On the phase shift mask 103 used in the present invention, a periodic stripe pattern of projections 150 and depressions 160 is formed. The phase shift mask 103 is manufactured by processing of a light-transmitting substrate having high smoothness with laser light. As the light-transmitting substrate, a quartz substrate can be used, for example. As laser light passes through the phase shift mask 103, the phase of laser light passing through the projections 150 is not inverted, but the phase of laser light passing through the depressions 160 is inverted 180°. By convergence of laser light transmitted through the phase shift mask 103 by a lens, as shown in FIG. 3C, the laser light can be changed into laser light having an intensity distribution 133 in which the periodicity of the phase shift mask 103 is reflected.

There is a step Δt between the surfaces of the projections and the surfaces of the depressions. Δt is obtained from the expression Δt=λ/2(n₁−n₀), where λ is the wavelength of laser light used, n₁ is the refractive index of a material of the phase shift mask, and n₀ is the refractive index of air.

In this embodiment mode, quartz is used as a material of the phase shift mask and its refractive index n₁ is 1.486. The refractive index n₀ is 1.000, and the wavelength λ is 532 nm in this embodiment mode. Thus, following the above expression, it is found that the step Δt is 547 nm.

Note that the material of the phase shift mask is not limited to quartz. For example, synthetic quartz having a refractive index n of 1.461, BK7 having a refractive index n of 1.519, SF6 having a refractive index n of 1.81, or the like can be used. When laser light of 532 nm is incident on a phase shift mask formed of synthetic quartz, the step Δt is 577 nm following the above expression. Similarly, when laser light of 532 nm is incident on a phase shift mask formed of BK7, the step Δt is 513 nm, and when laser light of 532 nm is incident on a phase shift mask formed of SF6, the step Δt is 328 nm. In addition, the phase shift mask 103 may be subjected to anti-reflection coating (AR coating).

The pitch of the stripe pattern of the phase shift mask 103 can be appropriately determined depending on the energy of a laser used and the scanning speed with laser light. In this embodiment mode, the pitch of the stripe pattern is set to be 2 μm.

Note that, because laser light may interfere at a front face (a laser light incident face) and a rear face of the phase shift mask 103, it is preferable that the phase shift mask be disposed at a tilt angle θ to the laser light scanning direction as shown in FIG. 3D. By disposition of the phase shift mask 103 in this manner, interference at the front face and the rear face of the phase shift mask 103 can be suppressed, and variations in laser light intensity within the beam spot along a long-axis direction can be reduced. However, by tilting of the phase shift mask 103, a maximum point 134 and a maximum point 135 are generated in the intensity distribution of laser light along a short-axis direction.

Here, when there are two maximum points in one beam spot, variations along a short-axis direction are caused. Therefore, the angle θ needs to be set so that the two maximum points 134 and 135 are generated apart from each other at a distance that is greater than a half of the width of the beam spot. That is, when the width of the beam spot is φ and the angle of refraction of laser light incident on the phase shift mask 103 is θ′, the tilt angle θ needs to satisfy φ<4d·tan θ′·cos θ. Note that the angle of refraction θ′ can be obtained from the expression θ′=sin⁻¹(θ/n), where the thickness of the phase shift mask 103 is d and the refractive index of a material of the phase shift mask is n.

In the laser irradiation apparatus shown in FIG. 1, laser light emitted from the laser 101 is incident on the optical system 110 after being bent by the mirror 102 to be perpendicular to the irradiation surface 111 which is provided over the stage 106. Laser light transmitted through the optical system 110 is shaped into a linear beam spot having an intensity distribution change along a long-axis direction as described above and then transferred to the irradiation surface 111 over the stage.

Furthermore, the stage 106 is moved at a constant speed in the direction of the arrow in FIG. 1, whereby the irradiation surface 111 can be entirely irradiated with laser light. In this embodiment mode, the stage 106 is an X-Y-θ stage and has mechanisms which move along X-axis, Y-axis, and θ-axis directions. Note that, when a direction of scanning with the beam spot is set perpendicular to a long-axis direction of the beam spot, high productivity can be obtained. Therefore, it is preferable that scanning be performed in a perpendicular direction to the long-axis direction.

Note that the energy distribution along the length direction of the beam spot, which is formed by the optical system 110, is a Gaussian distribution; therefore, small grain crystals are formed in portions at both ends of the beam spot where energy density is low. Thus, in order to irradiate the irradiation surface 111 with sufficient energy for formation of large grain crystals, a structure may be employed in which a slit or the like is provided between the laser 101 and the phase shift mask 103 to block end portions of a laser beam. Note that, when a slit is provided, for example, a cylindrical lens is disposed between the slit and the phase shift mask 103; an image obtained through the slit is formed on the phase shift mask 103; and an image of diffracted light generated by the phase shift mask 103 is formed on the irradiation surface 111 by the optical system 110.

The laser irradiation apparatus of the present invention transfers the light diffracted by the phase shift mask 103 to the irradiation surface 111 using the cylindrical lens 104 and the lens 105; therefore, a sufficient workspace can be made between the phase shift mask 103 and the irradiation surface 111.

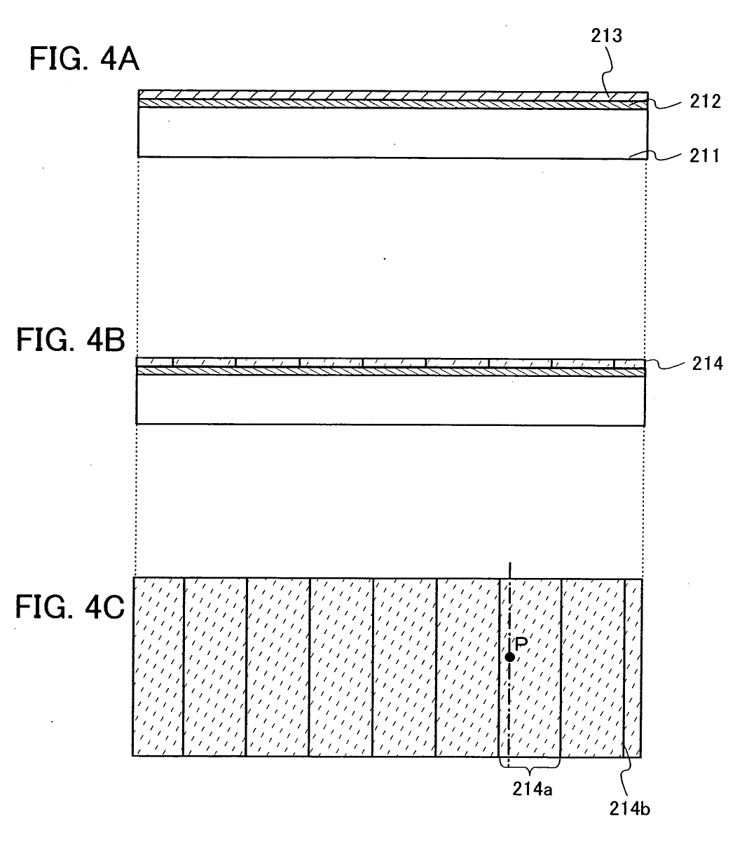

Next, a process of crystallizing a semiconductor film, which is provided over a substrate, using the laser irradiation apparatus of the present invention shown in FIG. 1 is described (FIGS. 4A to 4C).

For the substrate, a glass substrate 211 is used as an insulating substrate. The glass substrate 211 is not particularly limited and may be formed of quartz glass, alkali-free glass such as borosilicate glass, or aluminosilicate glass. It is acceptable as long as the glass substrate 211 has heat resistance or the like sufficient for a later step of forming a thin film. Note that not only a glass substrate but also any substrate that has an insulating surface and sufficient heat resistance may be used, and a material of the substrate is not particularly limited. That is, a plastic substrate having heat resistance sufficient to withstand a temperature during a step of forming a thin film, a stainless-steel substrate provided with an insulating film, or the like can also be used.

Borosilicate glass or the like contains a slight amount of an impurity such as sodium (Na), potassium (K), or the like, unlike quartz glass. When such an impurity is diffused around an active layer, a parasitic channel region is formed at an interface between the active layer and a base film or at an interface between the active layer and a gate insulating film. This causes an increase in leakage current generated during operation of a semiconductor element, for example, a TFT. In addition, the impurity diffused causes a shift in threshold voltage of a TFT. Accordingly, when a TFT is to be manufactured over the glass substrate 211, a structure is preferable in which an insulating film called a base film is interposed between the glass substrate and the TFT.

The base film is required to have the function of preventing diffusion of the impurity from the glass substrate and the function of improving adhesion to a thin film to be deposited over this insulating film. A material used for the base film is not particularly limited, and a material based on silicon oxide or a material based on silicon nitride may be used. Note that the material based on silicon oxide corresponds to silicon oxide mainly containing oxygen and silicon, or silicon oxynitride which is silicon oxide containing nitrogen in which the content of oxygen is higher than that of nitrogen. The material based on silicon nitride corresponds to silicon nitride mainly containing nitrogen and silicon, or silicon nitride oxide which is silicon nitride containing oxygen in which the content of nitrogen is higher than that of oxygen. Alternatively, the base film may have a structure in which films made of these materials are stacked. When the base film is formed by stacking, it is preferable that a material that serves as a blocking layer and prevents diffusion of an impurity mainly from the glass substrate be used for a lower layer portion that adheres to the glass substrate 211, and a material that mainly improves adhesion to a thin film to be deposited thereover be used for an upper layer portion.

In this embodiment mode, as a base film 212, a silicon oxynitride layer having a thickness of 50 nm to 150 nm and then a silicon nitride oxide layer having a thickness of 50 nm to 150 nm are stacked over the glass substrate 211. When inexpensive Corning glass or the like is used for the substrate and a TFT portion is formed in contact with the substrate, movable ions of sodium or the like enter. Therefore, the silicon nitride film is formed as a blocking layer. The base film 212 can be formed by a method such as a CVD method, a plasma CVD method, a sputtering method, or a spin coating method. Note that the base film does not necessarily need to be formed if not necessary.

Next, an amorphous semiconductor film 213 is formed over the base film 212 (FIG. 4A). Here, the amorphous semiconductor film 213 is formed using amorphous silicon. The amorphous semiconductor film 213 is formed by a low-pressure CVD (LPCVD) method, a plasma CVD method, a vapor phase growth method, or a sputtering method using a semiconductor source gas such as silane (SiH₄). The thickness of the amorphous semiconductor film 213 is 20 nm to 200 nm, preferably, 20 nm to 100 nm, more preferably, 20 nm to 80 nm.

Note that, although amorphous silicon is used for the amorphous semiconductor film 213 in this embodiment mode, polycrystalline silicon, silicon germanium (Si₁₋ₓGeₓ (0<x<0.1)), silicon carbide (SiC) in which a single crystal has a diamond structure, or the like can be used.

Then, if necessary, an oxide film formed on the surface of the amorphous semiconductor film 213 by natural oxidation or the like is removed. By removal of the oxide film formed on the surface, an impurity that exists in the oxide film or on the oxide film can be prevented from entering and diffusing into the semiconductor film by crystallization.

Next, the amorphous semiconductor film 213 is crystallized. In the present invention, the amorphous semiconductor film 213 is crystallized using the laser irradiation apparatus shown in FIG. 1. Specifically, the glass substrate 211 is disposed over the stage 106 of the laser irradiation apparatus shown in FIG. 1 and is entirely irradiated with laser light as the stage 106 is moved. That is, in this embodiment mode, the irradiation surface 111 in FIG. 1 corresponds to the amorphous semiconductor film 213 in FIG. 4A.

As described above, in the laser irradiation apparatus of the present invention, a CW laser or a quasi-CW laser is used as the laser. When a semiconductor film is irradiated with CW laser light, energy can be continuously applied to the semiconductor film. Therefore, once the semiconductor film is brought into a melted state, the melted state can be retained. Moreover, a solid-liquid interface of the semiconductor film can be moved by scanning with laser light and a crystal grain which is long in one direction along the direction of this movement can be formed. When a quasi-CW laser is used for irradiation of a semiconductor film, the semiconductor film can be continuously retained in a melted state if the pulse interval of the laser is shorter than the length of time it takes for the semiconductor film to be solidified after being melted, and a semiconductor film made of crystal grains which are long in one direction can be formed by movement of the solid-liquid interface.

In this embodiment mode, the surface of the amorphous semiconductor film is irradiated with laser light through the phase shift mask having a stripe pattern. In general, when the amorphous semiconductor film is irradiated with laser light, if a large area is completely melted, initial crystal nuclei are generated at various locations within the completely melted region, and random crystal growth is caused in which the crystal nuclei repetitively grow and meet each other. However, in this embodiment mode, laser light has intensity distribution in which the stripe pattern of the phase shift mask is reflected along the long-axis direction. Therefore, places where grain boundaries are likely to remain due to temperature gradient can be locally and periodically arranged, and crystal zones each having a width nearly equal to the pitch of the stripe pattern can be generated along a laser light irradiation direction. That is, by use of the laser irradiation apparatus of the present invention for crystallization of an amorphous semiconductor film, positions at which crystal nuclei are generated can be controlled.

Note that it is acceptable that the laser light used in the present invention has a wavelength that is absorbed by the amorphous semiconductor film 213. In this embodiment mode, because silicon is used for the amorphous semiconductor film 213, the wavelength of the laser light used is 800 nm or less, which is absorbed by silicon, preferably, about 200 nm to 500 nm, more preferably, about 350 nm to 550 nm.

Note that, before the amorphous semiconductor film 213 is crystallized, a dehydrogenation step may be performed if necessary. For example, when the amorphous semiconductor film 213 is formed by a normal CVD method using silane (SiH₄), hydrogen remains in the film. However, when the semiconductor film in a state where hydrogen remains in the film is irradiated with laser light, a part of the film is eliminated with laser light having an energy value that is about half the most suitable energy value for crystallization. Thus, it is preferable that hydrogen remaining in the film be reduced in amount or removed by heating in an N₂ atmosphere. When the amorphous semiconductor film 213 is formed by an LPCVD method or a sputtering method, a dehydrogenation step is not necessarily needed.

In addition, if necessary, channel doping may be performed before the amorphous semiconductor film 213 is crystallized. Channel doping refers to addition of an impurity to an active layer of a semiconductor layer at a predetermined concentration to intentionally shift a threshold voltage of a TFT and to control the threshold voltage of the TFT to be a desired value. For example, when the threshold voltage is shifted to a negative side, a p-type impurity element is added as a dopant, and when the threshold voltage is shifted to a positive side, an n-type impurity element is added as the dopant. Here, examples of p-type impurity elements include phosphorus (P), arsenic (As), and the like and examples of n-type impurity elements include boron (B), aluminum (Al), and the like.

Furthermore, in the manufacturing method of a semiconductor device of the present invention, a crystallization step using an element which accelerates crystallization (hereinafter, a catalytic element) may be performed before crystallization with a laser beam. As the catalytic element, an element such as nickel (Ni), germanium (Ge), iron (Fe), palladium (Pd), tin (Sn), lead (Pb), cobalt (Co), platinum (Pt), copper (Cu), or gold (Au) can be used. When the crystallization step with a laser beam is performed after the crystallization step using a catalytic element, a crystal formed during the crystallization using a catalytic element remains without being melted by irradiation with a laser beam, and crystallization is advanced using this crystal as a crystal nucleus.

For this reason, compared to the case in which only the crystallization step with a laser beam is performed, crystallinity of the semiconductor film can be improved even more, and the degree of roughness on the surface of the semiconductor film after the crystallization with a laser beam can be suppressed. That is, by crystallization using a catalytic element, variations in characteristics of semiconductor elements (for example, TFTs) to be formed later can be suppressed. Note that crystallinity may be improved even more by irradiation with a laser beam after the catalyst element is added and heat treatment is then performed to accelerate the crystallization. The step of heat treatment may be omitted. Specifically, crystallinity may be improved by irradiation with a laser beam instead of the heat treatment after a catalytic element is added.

In the manner described above, by application of the present invention, a crystalline semiconductor film 214 formed of large grain crystals, in which positions at which crystal nuclei are generated are controlled and grain boundaries are extended in one direction, can be obtained as shown in FIGS. 4B and 4C. In addition, because positions at which crystal nuclei are generated can be controlled by the present invention, positions at which crystal grain boundaries are generated, the generation direction, and the number of boundaries per unit area can be controlled. Note that FIG. 4B shows a side view of the glass substrate 211 over which the crystalline semiconductor film 214 is formed, and FIG. 4C shows a top view of the glass substrate 211 over which the crystalline semiconductor film 214 is formed.

Note that, in the crystalline semiconductor film of the present invention, as shown in FIG. 4C, there is a plurality of boundaries 214b between crystal zones, which is extended in one direction, and each region divided by the boundaries 214b between crystal zones corresponds to a crystal zone 214a. Note that the crystal zone 214a includes one or more crystal grains, but it is preferable that it include one crystal grain. When the crystal zone is formed to include one crystal grain, a polycrystalline semiconductor in which there is no grain boundary like a single crystal can be formed.

A line, which passes through a given point (in FIG. 4C, a point P) in the crystal zone 214a and is drawn parallel to one of the boundaries 214b of the crystal zone, does not cross the other of the boundaries 214b of the crystal zone. In addition, according to this embodiment mode, no crystal grain boundary that crosses the boundaries 214b of the crystal zone 214a is formed in the crystal zone. Accordingly, when a channel formation region of a TFT is provided within the crystal zone 214a so that the channel length direction is roughly parallel to the boundaries 214b of the crystal zone, a TFT having high mobility and favorable electrical characteristics can be manufactured.

Moreover, the laser irradiation apparatus of the present invention transfers the light diffracted by the phase shift mask to the irradiation surface by use of the cylindrical lens and the lens. Accordingly, while periodicity of intensity distribution along a long-axis direction of laser light used for irradiation is maintained, a sufficient workspace can be made between the phase shift mask and the irradiation surface, and operation efficiency is improved.

Furthermore, because a TFT having favorable electrical characteristics can be manufactured by the present invention, a circuit element having higher performance than before can be formed. Accordingly, a semiconductor device having higher added value than before can be manufactured over a glass substrate.

### Embodiment Mode 2

In this embodiment mode, a manufacturing method of a crystalline semiconductor film through a manufacturing process different from that of the crystalline semiconductor film described in Embodiment Mode 1 is described. Note that description of the same structure as that in Embodiment Mode 1 is simplified and partially omitted.

First, similar to the manufacturing process described in Embodiment Mode 1 with reference to FIGS. 4A to 4C, a base film 212 and an amorphous semiconductor film 213 are formed over a glass substrate 211. Note that the amorphous semiconductor film 213 may be heated in an electric furnace at 500° C. for an hour after being formed. This heat treatment is treatment for dehydrogenating the amorphous semiconductor film. Note that dehydrogenation is performed to prevent a hydrogen gas from being discharged from the amorphous semiconductor film 213 when the amorphous semiconductor film 213 is irradiated with laser light, and can be omitted when the amount of hydrogen contained in the amorphous semiconductor film 213 is small.

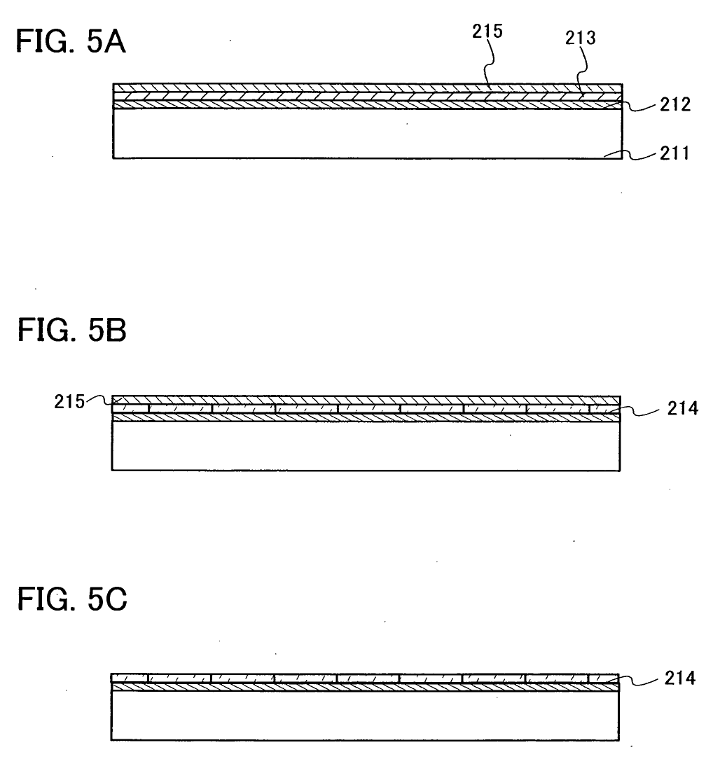

Next, a cap film 215 having a thickness of 200 nm to 1000 nm is formed over the amorphous semiconductor film 213 (FIG. 5A). It is preferable that the cap film 215 be a film having enough transmittance at a wavelength of laser light and having a thermal value such as a thermal expansion coefficient or a value such as ductility which is close to that of the adjacent semiconductor film. It is also preferable that the cap film 215 be a hard dense film like a gate insulating film of a thin film transistor to be formed later. Such a hard dense film can be formed by, for example, decreasing the deposition rate. The deposition rate is preferably 1 nm/min to 400 nm/min, more preferably, 1 nm/min to 100 nm/min.

Note that, when the cap film contains a large amount of hydrogen, in a similar manner to the amorphous semiconductor film 213, it is preferable that heat treatment be performed for dehydrogenation.

The cap film 215 can be formed of a single layer structure of a silicon nitride film, a silicon oxide film containing nitrogen, a silicon nitride film containing oxygen, or the like. Alternatively, a cap film in which a silicon oxide film containing nitrogen and a silicon nitride film containing oxygen are sequentially stacked, or a cap film in which a silicon nitride film containing oxygen and a silicon oxide film containing nitrogen are sequentially stacked can be formed. Furthermore, a plurality of films is stacked as a cap film, and a light interference effect due to a thin film is utilized, whereby light absorption efficiency of the amorphous semiconductor film 213 can be enhanced. With the use of the cap film having such a structure, the amorphous semiconductor film 213 can be crystallized using laser light having low energy; thus, cost can be reduced.

In this embodiment mode, as the cap film 215, a silicon nitride film is formed, which has a thickness of 200 nm to 1000 nm, contains oxygen at 0.1 at. % to 10 at. %, and has a composition ratio of nitrogen to silicon of 1.3 to 1.5.

As this cap film 215, in this embodiment mode, a silicon nitride film containing oxygen with a thickness of 300 nm is formed by a plasma CVD method using monosilane (SiH₄), ammonia (NH₃), and nitrous oxide (N₂O) as a reaction gas. Note that nitrous oxide (N₂O) is used as an oxidizer, and instead of nitrous oxide, oxygen which has an oxidizing effect may be used.

Next, the glass substrate 211 is placed over the stage of the laser irradiation apparatus of the present invention shown in FIG. 1, and the cap film 215 is irradiated with laser light from above to crystallize the amorphous semiconductor film 213, thereby forming a crystalline semiconductor film 214 (FIG. 5B). The cap film 215 is removed after the amorphous semiconductor film 213 is crystallized (FIG. 5C).

Through the above-described process, the crystalline semiconductor film 214 can be obtained. With the laser irradiation apparatus of the present invention, a linear beam spot having intensity distribution along a long-axis direction of laser light as described above can be formed, and by irradiation of the entire substrate with such laser light, a crystalline semiconductor film of the present invention, which has a crystal zone that is dependent on the intensity distribution of laser light, can be formed.

According to this embodiment mode, no crystal grain boundary that crosses the boundaries of the crystal zone is formed. Therefore, when a TFT is provided so that a channel length direction of the TFT is roughly parallel to the boundaries of the crystal zone, a TFT having high mobility and favorable electrical characteristics can be manufactured.

Furthermore, because a TFT having favorable electrical characteristics can be manufactured by the present invention, a circuit element with higher performance than before can be formed. Accordingly, a semiconductor device with higher added value than before can be manufactured over a glass substrate.

In this embodiment mode, the amorphous semiconductor film 213 is irradiated with laser light through the cap film 215. Therefore, surface roughness can be suppressed compared to the case where the amorphous semiconductor film 213 is directly irradiated with laser light. Accordingly, in a semiconductor element which is manufactured using a crystalline semiconductor film, a semiconductor film and a gate insulated film can be made in contact with each other, and an element having a high withstand voltage can be obtained even when the thickness of the gate insulating film is reduced.

Note that this embodiment mode can be freely combined with any of the other embodiment modes.

### Embodiment Mode 3

In this embodiment mode, an example of a process for manufacturing a thin film transistor (TFT) using a crystalline semiconductor film which is manufactured using the laser irradiation apparatus of the present invention is described. Note that, in this embodiment mode, a manufacturing method of a top-gate (staggered) TFT is described; however, the present invention is not limited to a top-gate TFT and can be similarly applied to a bottom-gate (inverted staggered) TFT or the like. In addition, the present invention can be carried out in many different modes, and it is easily understood by those skilled in the art that the mode and detail of the present invention can be changed in various ways without departing from the spirit and scope thereof. Therefore, the present invention should not be interpreted as being limited to the description in this embodiment mode.

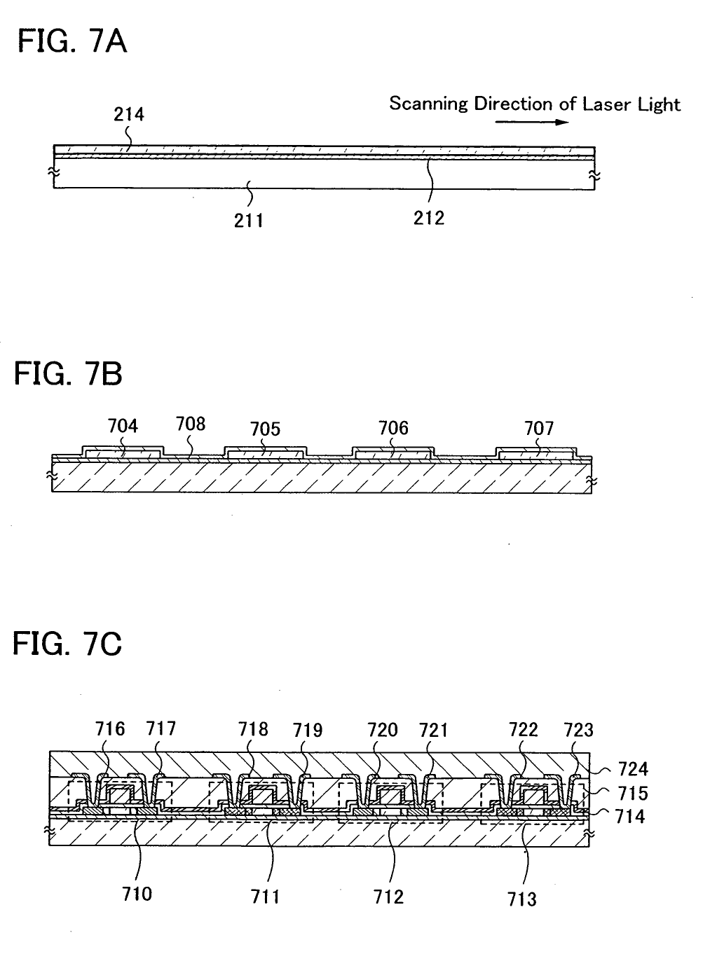

First, as shown in FIG. 7A, a silicon nitride film and a silicon oxide film as a base film 212 and a crystalline semiconductor film 214 which is crystallized using the laser irradiation apparatus of the present invention are sequentially stacked over a glass substrate 211. Note that steps to the step of forming the crystalline semiconductor film 214 can be performed similar to the steps described in Embodiment Mode 1 or 2.

The crystalline semiconductor film 214 has a plurality of crystal zones, in which crystal grains which have been continuously grown in a scanning direction are formed by scanning with a linear beam spot in the direction of an arrow shown in FIG. 7A. In this embodiment mode, the crystalline semiconductor film 214 is formed so that boundaries of each crystal zone are roughly parallel to a carrier transfer direction in a channel of a TFT. Therefore, it is possible to form a TFT in which there is almost no grain boundary along a carrier transfer direction in a channel.

Next, as shown in FIG. 7B, the crystalline semiconductor film 214 is etched to form island-shaped semiconductor films 704 to 707. Then, a gate insulating film 708 is formed to cover the island-shaped semiconductor films 704 to 707. The gate insulating film 708 can be formed using, for example, silicon oxide, silicon nitride, silicon nitride oxide, or the like. In that case, the gate insulating film 708 can be formed by a plasma CVD method, a sputtering method, or the like. For example, a silicon-containing insulating film may be formed by a sputtering method to a thickness of 30 nm to 200 nm.

Next, a conductive film is formed over the gate insulating film 708 and then etched, thereby forming gate electrodes. After that, using as masks the gate electrodes or a resist which is etched after formation, impurities which each impart n-type or p-type conductivity are selectively added to the island-shaped semiconductor films 704 to 707 to form source regions, drain regions, and LDD regions. Accordingly, n-type or p-type transistors 710 and 712 and transistors 711 and 713 having the opposite conductivity type to that of the transistors 710 and 712 can be formed over the same substrate (FIG. 7C). Next, an insulating film 714 is formed as a protective film for these transistors. This insulating film 714 may be formed as a single-layer structure or a stacked-layer structure of a silicon-containing insulating film with a thickness of 100 nm to 200 nm by a plasma CVD method or a sputtering method. For example, a silicon oxynitride film may be formed by a plasma CVD method to a thickness of 100 nm.

Then, an organic insulating film 715 is formed over the insulating film 714. The organic insulating film 715 is formed using an organic insulating film of polyimide, polyamide, BCB, acrylic, or the like applied by an SOG method. The organic insulating film 715 is preferably a film having high planarity because the organic insulating film 715 is formed mainly with a purpose of relaxing and planarizing unevenness due to the TFTs formed over the glass substrate 211. In addition, the insulating film 714 and the organic insulating film 715 are processed by patterning using a photolithography method to form contact holes that reach impurity regions.

Next, a conductive film is formed using a conductive material and then processed by patterning to form wirings 716 to 723. After that, an insulating film 724 is formed as a protective film, whereby a semiconductor device as shown in FIG. 7C is completed.

Note that the manufacturing method of a semiconductor device of the present invention is not limited to the above-described process for manufacturing a TFT. For example, the structure of a TFT may be a so-called GOLD (gate-drain overlapped LDD) structure in which an LDD region is arranged to overlap with a gate electrode with a gate insulating film interposed therebetween. Furthermore, before crystallization with a laser beam, a crystallization step using a catalytic element may be provided. As the catalytic element, an element such as nickel (Ni), germanium (Ge), iron (Fe), palladium (Pd), tin (Sn), lead (Pb), cobalt (Co), platinum (Pt), copper (Cu), or gold (Au) can be used.

The crystalline semiconductor film formed by application of the present invention, in which positions at which nuclei of crystals are generated are controlled, is formed of large grain crystals whose grain boundaries are extended along one direction. Thus, by use of the crystalline semiconductor film of the present invention, mobility is increased; thus a semiconductor device having favorable electrical characteristics can be manufactured. The manufacturing method of a semiconductor device using the present invention can be used for manufacturing methods of an integrated circuit and a semiconductor display device. Transistors to be applied to a functional circuit such as a driver or a CPU preferably have an LDD structure or a structure in which an LDD overlaps with a gate electrode. Because each of the transistors 710 to 713 completed in this embodiment mode has an LDD structure, the transistors 710 to 713 are suitable for use in a driver circuit that requires a low I_{off} value.

### Embodiment Mode 4

A semiconductor device of the present invention can be applied to an integrated circuit such as a central processing unit (CPU). In this embodiment mode, an example of a CPU to which a semiconductor device manufactured using the present invention is applied is hereinafter described with reference to a drawing.

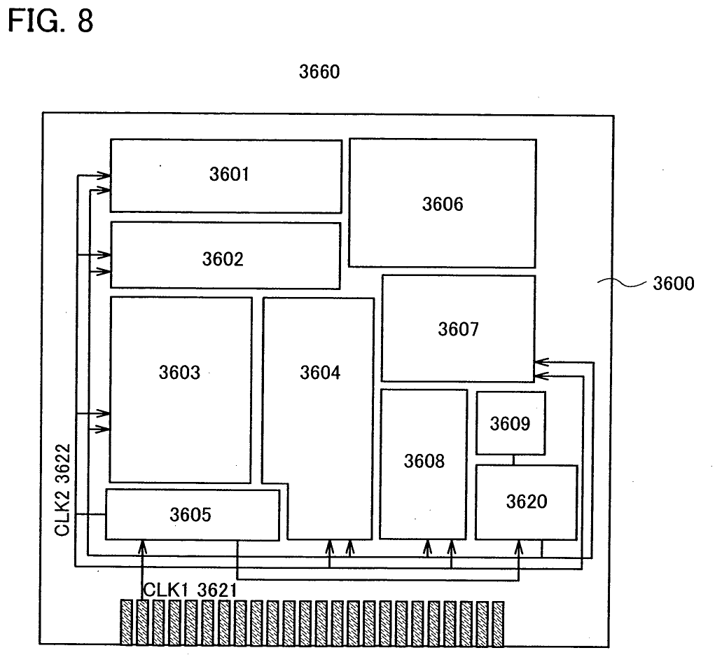

A CPU 3660 shown in FIG. 8 mainly has, over a substrate 3600, an arithmetic logic unit (ALU) 3601, an ALU controller 3602, an instruction decoder 3603, an interrupt controller 3604, a timing controller 3605, a register 3606, a register controller 3607, a bus interface (Bus I/F) 3608, a rewritable ROM 3609, and a ROM interface (ROM I/F) 3620. The ROM 3609 and the ROM interface 3620 may be provided on another chip as well. These various circuits included in the CPU 3660 can be formed using thin film transistors, which are formed using a crystalline semiconductor film crystallized with the laser irradiation apparatus of the present invention, or a CMOS circuit, an nMOS circuit, a pMOS circuit, or the like, which is a combination of such thin film transistors.

The CPU 3660 shown in FIG. 8 is merely an example in which the configuration is simplified, and actual CPUs may have various configurations depending on the uses. Therefore, the configuration of a CPU to which the present invention is applied is not limited to that shown in FIG. 8.

An instruction input to the CPU 3660 through the bus interface 3608 is input to the instruction decoder 3603, decoded therein, and then input to the ALU controller 3602, the interrupt controller 3604, the register controller 3607, and the timing controller 3605.

The ALU controller 3602, the interrupt controller 3604, the register controller 3607, and the timing controller 3605 conduct various controls based on the decoded instruction. Specifically, the ALU controller 3602 generates signals for controlling the operation of the ALU 3601. While the CPU 3660 is executing a program, the interrupt controller 3604 processes an interrupt request from an external input/output device or a peripheral circuit based on its priority or a mask state. The register controller 3607 generates an address of the register 3606, and reads and writes data from and to the register 3606 depending on the state of the CPU.

The timing controller 3605 generates signals for controlling timing of operation of the ALU 3601, the ALU controller 3602, the instruction decoder 3603, the interrupt controller 3604, and the register controller 3607. For example, the timing controller 3605 is provided with an internal clock generator for generating an internal clock signal CLK2 (3622) based on a reference clock signal CLK1 (3621), and supplies the clock signal CLK2 to the above-mentioned various circuits.

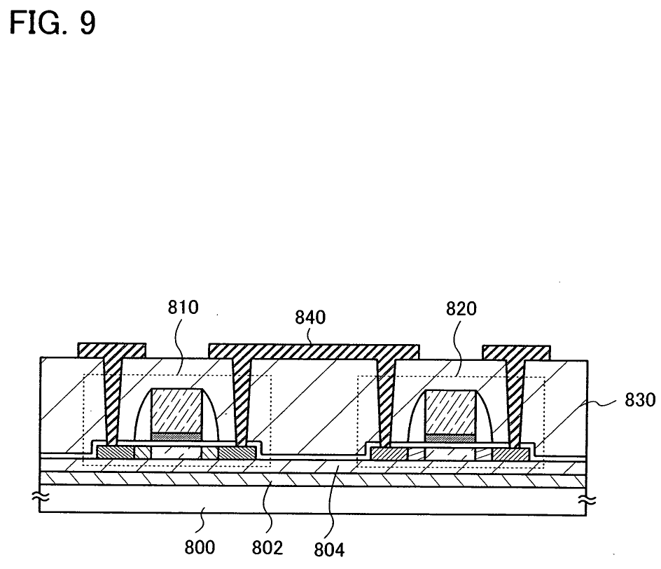

Here, an example of a CMOS circuit that can be applied to the CPU 3660 is described (see FIG. 9). In a CMOS circuit shown in FIG. 9, a transistor 810 and a transistor 820 are formed over a substrate 800 with insulating layers 802 and 804 which serve as a base film interposed therebetween. An insulating layer 830 is formed to cover the transistor 810 and the transistor 820, and a conductive layer 840 is formed to be electrically connected to the transistor 810 and the transistor 820 with the insulating layer 830 interposed therebetween. The transistor 810 and the transistor 820 are electrically connected to each other by the conductive layer 840. Each of the transistor 810 and the transistor 820 uses as an active layer a crystalline semiconductor film which is crystallized using the laser irradiation apparatus of the present invention.

As the substrate 800, a substrate having an insulating surface may be used. For example, a glass substrate, a quartz substrate, a sapphire substrate, a ceramic substrate, a metal substrate provided with an insulating layer on its surface, or the like can be used.

The insulating layers 802 and 804 are each formed by a CVD method, a sputtering method, or an ALD method using a material such as silicon oxide, silicon nitride, silicon oxynitride, or silicon nitride oxide. The insulating layers 802 and 804 each function as a blocking layer which prevents the transistor 810 and the transistor 820 from being contaminated by an alkali metal or the like diffusing from the substrate 800. In addition, when the substrate 800 has an uneven surface, the insulating layers 802 and 804 can each function as a planarizing layer. Note that, when impurity diffusion from the substrate 800 or unevenness of the surface of the substrate 800 does not become an issue, the insulating layers 802 and 804 do not necessarily need to be formed. Here, the base insulating layer has a two-layer structure, but it may have a single-layer structure or a stacked-layer structure of three or more layers.

The transistor 810 and the transistor 820 have different conductivity types. For example, the transistor 810 may be formed as an n-channel transistor, and the transistor 820 may be formed as a p-channel transistor.

The insulating layer 830 is formed by a CVD method, a sputtering method, an ALD method, a coating method, or the like using an inorganic insulating material containing oxygen or nitrogen such as silicon oxide, silicon nitride, silicon oxynitride, or silicon nitride oxide, an insulating material containing carbon such as diamond-like carbon (DLC), an organic insulating material such as epoxy, polyimide, polyamide, polyvinylphenol, benzocyclobutene, or acrylic, or a siloxane material such as a siloxane resin. Note that a siloxane material corresponds to a material having a Si—O—Si bond. Siloxane has a skeleton formed from a bond of silicon (Si) and oxygen (O). As a substituent, an organic group containing at least hydrogen (for example, an alkyl group or an aromatic hydrocarbon) is used. As the substituent, a fluoro group can alternatively be used. Still alternatively, a fluoro group and an organic group containing at least hydrogen may be used as the substituent. The insulating layer 830 may alternatively be formed by formation of an insulating layer using a CVD method, a sputtering method, or an ALD method and then by high-density plasma processing of the insulating layer in an oxygen atmosphere or a nitrogen atmosphere. Here, an example is described in which the insulating layer 830 has a single-layer structure, but the insulating layer 830 may have a stacked-layer structure of two or more layers. Alternatively, the insulating layer 830 may be formed using a combination of an inorganic insulating layer and an organic insulating layer.

The conductive layer 840 is formed as a single-layer structure or a stacked-layer structure by a CVD method or a sputtering method using a metal element such as aluminum, tungsten, titanium, tantalum, molybdenum, nickel, platinum, copper, gold, silver, manganese, neodymium, carbon, or silicon or an alloy material or a compound material containing any of the metal elements. As an alloy material containing aluminum, for example, a material containing aluminum as its main component and containing nickel or an alloy material containing aluminum as its main component and containing nickel and one or both of carbon and silicon can be used. For the conductive layer 840, a stacked-layer structure of a barrier layer, an aluminum silicon layer, and a barrier layer or a stacked-layer structure of a barrier layer, an aluminum silicon layer, a titanium nitride layer, and a barrier layer can be employed. Note that the barrier layer corresponds to a thin film formed of titanium, a nitride of titanium, molybdenum, or a nitride of molybdenum. Because aluminum or aluminum silicon has a low resistance and is inexpensive, aluminum or aluminum silicon is most suitable as a material for forming the conductive layer 840. In addition, it is preferable that upper and lower barrier layers be provided because generation of a hillock on aluminum or aluminum silicon can be prevented.

The conductive layer 840 functions as a source electrode or a drain electrode. The conductive layer 840 is electrically connected to the transistor 810 and the transistor 820 through openings which are formed in the insulating layer 830. Specifically, the conductive layer 840 is electrically connected to a source region or a drain region of the transistor 810 and a source region or a drain region of the transistor 820. In addition, the source region or drain region of the transistor 810 is electrically connected to the source region or drain region of the transistor 820 through the conductive layer 840. In the manner described above, a CMOS circuit can be formed.

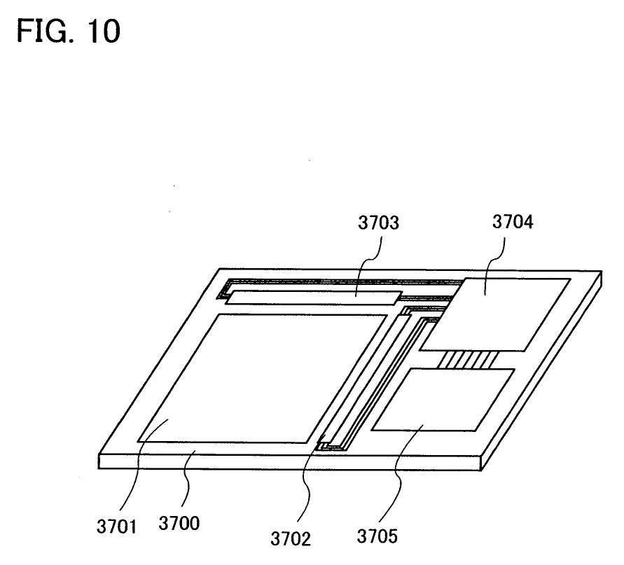

FIG. 10 shows a display device in which a pixel portion, a CPU, and other circuits are formed over the same substrate, that is, a so-called system-on-panel display. Over a substrate 3700, a pixel portion 3701, a scan line driver circuit 3702 which selects a pixel included in the pixel portion 3701, and a signal line driver circuit 3703 which supplies a video signal to a pixel selected are provided. Through wirings lead out from the scan line driver circuit 3702 and the signal line driver circuit 3703, a CPU 3704 and other circuits (such as a control circuit 3705) are connected. Note that the control circuit has an interface. In addition, a connection portion for an FPC terminal is provided in an edge portion of the substrate for exchange of signals with an external device.

As other circuits, besides the control circuit 3705, a video signal processing circuit, a power supply circuit, a gray-scale power supply circuit, a video RAM, a memory (a DRAM, an SRAM, or a PROM), and the like can be provided. These circuits may be formed on an IC chip and may be mounted on the substrate. The scan line driver circuit 3702 and the signal line driver circuit 3703 do not necessarily need to be formed over the same substrate. For example, only the scan line driver circuit 3702 may be formed over a substrate, and the signal line driver circuit 3703 may be formed on an IC chip and mounted.

Note that, although the example in which the semiconductor device of the present invention is applied to a CPU is described in this embodiment mode, the present invention is not particularly limited. For example, the semiconductor device of the present invention can be applied to a pixel portion, a driver circuit portion, or the like of a display device having an organic light-emitting element, an inorganic light-emitting element, a liquid crystal display element, or the like. In addition, by application of the present invention, a digital camera, a sound reproducing device such as a car audio system, a notebook personal computer, a game machine, a portable information terminal (such as a cellular phone or a portable game machine), an image reproducing device having a recording medium such as a home-use game machine, or the like can also be manufactured.

By use of a crystalline semiconductor film of the present invention, a semiconductor device having favorable electrical characteristics can be manufactured. In addition, in the semiconductor device to which the present invention is applied, variations in characteristics of semiconductor elements such as transistors can be suppressed. Accordingly, a semiconductor device having high reliability can be provided.

### Embodiment Mode 5

In this embodiment mode, examples of application modes of the semiconductor device described in the foregoing embodiment modes are described. Specifically, application examples of a semiconductor device capable of inputting and outputting data without contact are described below with reference to drawings. The semiconductor device capable of inputting and outputting data without contact is also called an RFID tag, an ID tag, an IC tag, an IC chip, an RF tag, a wireless tag, an electronic tag, or a wireless chip depending on the application mode.

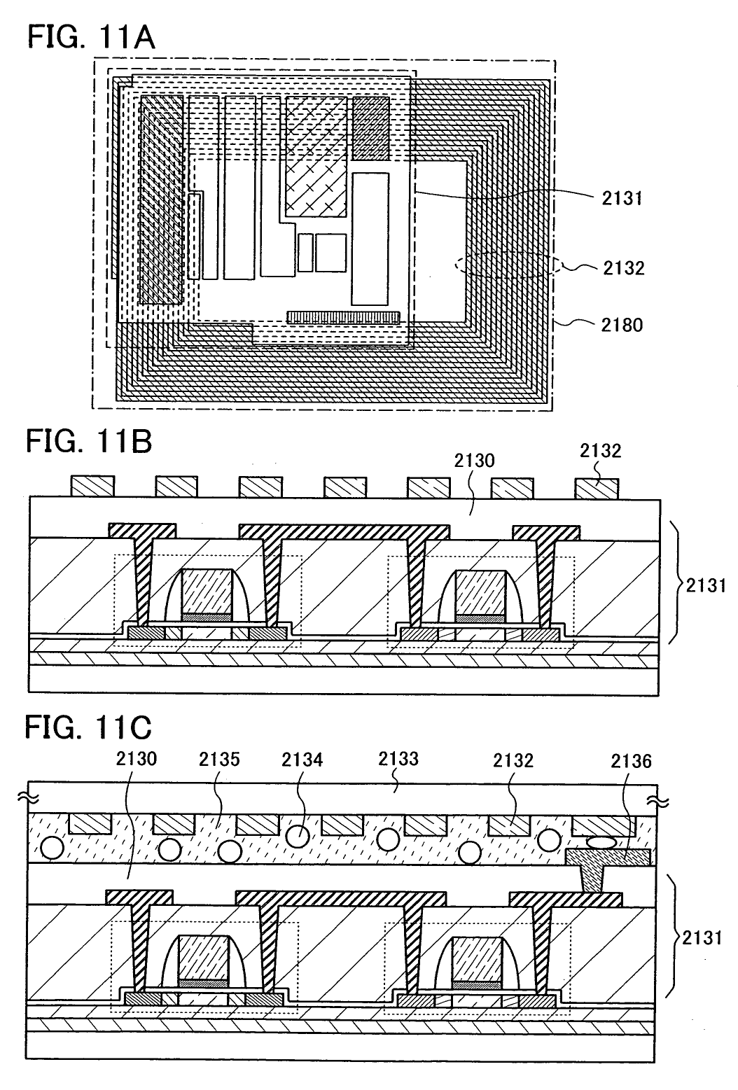

One example of an upper surface structure of a semiconductor device of this embodiment mode is described with reference to FIG. 11A. A semiconductor device 2180 shown in FIG. 11A includes a thin film integrated circuit 2131 provided with a plurality of elements such as thin film transistors for forming a memory portion and a logic portion, and a conductive layer 2132 which functions as an antenna. The conductive layer 2132 which functions as an antenna is electrically connected to the thin film integrated circuit 2131. For the thin film integrated circuit 2131, a thin film transistor formed using a crystalline semiconductor film which is crystallized with the laser irradiation apparatus of the present invention can be used.

Schematic cross-sectional views of FIG. 11A are shown in FIGS. 11B and 11C. The conductive layer 2132 which functions as an antenna may be provided above the elements for forming the memory portion and the logic portion; for example, the conductive layer 2132 which functions as an antenna can be provided above the thin film integrated circuit 2131 including the thin film transistors described in the above embodiment modes with an insulating layer 2130 interposed therebetween (see FIG. 11B). Alternatively, the conductive layer 2132 which functions as an antenna may be provided over a substrate 2133 and then the substrate 2133 and the thin film integrated circuit 2131 may be attached to each other so as to sandwich the conductive layer 2132 (see FIG. 11C). FIG. 11C shows an example in which a conductive layer 2136 provided over the insulating layer 2130 and the conductive layer 2132 which functions as an antenna are electrically connected to each other through conductive particles 2134 contained in an adhesive resin 2135.

Note that, although an example in which the conductive layer 2132 which functions as an antenna is provided in a coil shape and either an electromagnetic induction method or an electromagnetic coupling method is employed is described in this embodiment mode, the semiconductor device of the present invention is not limited thereto, and a microwave method may be employed as well. In the case of a microwave method, the shape of the conductive layer 2132 which functions as an antenna may be determined as appropriate depending on the wavelength of an electromagnetic wave used.

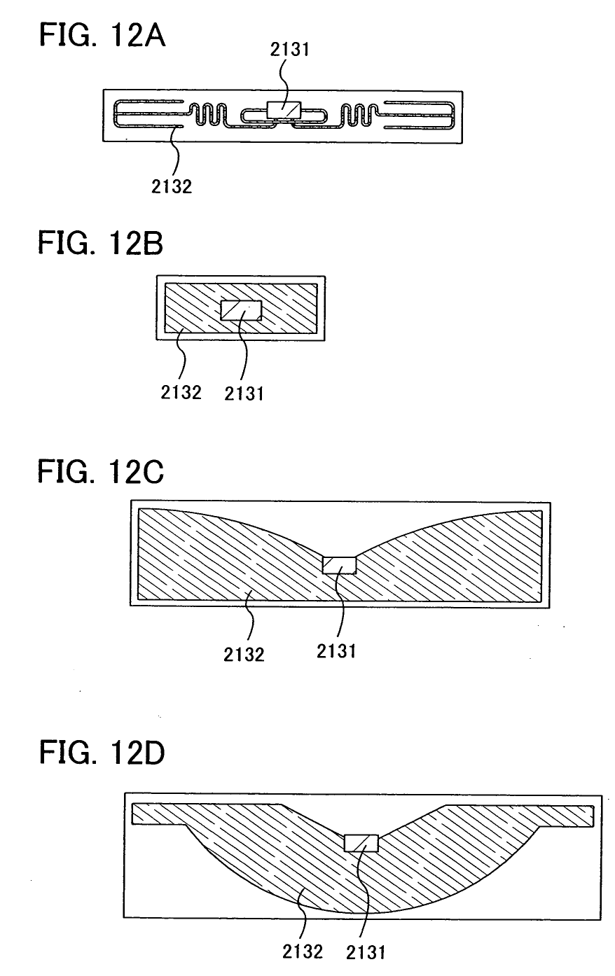

For example, when the microwave method (e.g., with a UHF band (in the range of 860 MHz to 960 MHz), a frequency band of 2.45 GHz, or the like) is employed as the signal transmission method of the semiconductor device 2180, the shape such as length of the conductive layer which functions as an antenna may be set as appropriate in consideration of the wavelength of an electromagnetic wave used in sending a signal. For example, the conductive layer which functions as an antenna can be formed in a linear shape (e.g., a dipole antenna (see FIG. 12A)), in a flat shape (e.g., a patch antenna (see FIG. 12B)), in a ribbon shape (see FIGS. 12C and 12D), or the like. Further, the shape of the conductive layer 2132 which functions as an antenna is not limited to a straight line, and the conductive layer in the shape of a curved line, in a serpentine shape, or in a shape combining them may also be provided in consideration of the wavelength of the electromagnetic wave.

The conductive layer 2132 which functions as an antenna is formed of a conductive material by a CVD method, a sputtering method, a printing method such as a screen printing method or a gravure printing method, a droplet discharge method, a dispenser method, a plating method, or the like. The conductive material may be any of metal elements such as aluminum, titanium, silver, copper, gold, platinum, nickel, palladium, tantalum, molybdenum, and the like, or an alloy material or a compound material including any of the above metal elements, and the conductive layer 2132 is formed to have a single-layer structure or a stacked-layer structure.

For example, when the conductive layer 2132 which functions as an antenna is formed by a screen printing method, the conductive layer 2132 can be provided by selective printing of a conductive paste in which conductive particles with a grain diameter of several nanometers to several tens of micrometers are dissolved or dispersed in an organic resin. The conductive particles can be any one or more of metal particles selected from silver, gold, copper, nickel, platinum, palladium, tantalum, molybdenum, titanium, and the like; fine particles of silver halide; and dispersive nanoparticles thereof. In addition, the organic resin included in the conductive paste can be one or more of organic resins which function as a binder, a solvent, a dispersing agent, and a coating material of the metal particles. Typically, organic resins such as an epoxy resin and a silicone resin can be given as examples. Preferably, a conductive paste is extruded and then baked to form the conductive layer. For example, when fine particles (e.g., fine particles having a grain diameter of 1 nm to 100 nm) containing silver as its main component are used as a material of the conductive paste, the conductive paste is baked and hardened at a temperature of 150° C. to 300° C., whereby the conductive layer can be obtained. Alternatively, it is also possible to use fine particles containing solder or lead-free solder as its main component, in which case it is preferable that fine particles having a grain diameter of 20 μm or less be used. Solder and lead-free solder have the advantage of low cost and the like.

Next, an example of operation of the semiconductor device of this embodiment mode is described.

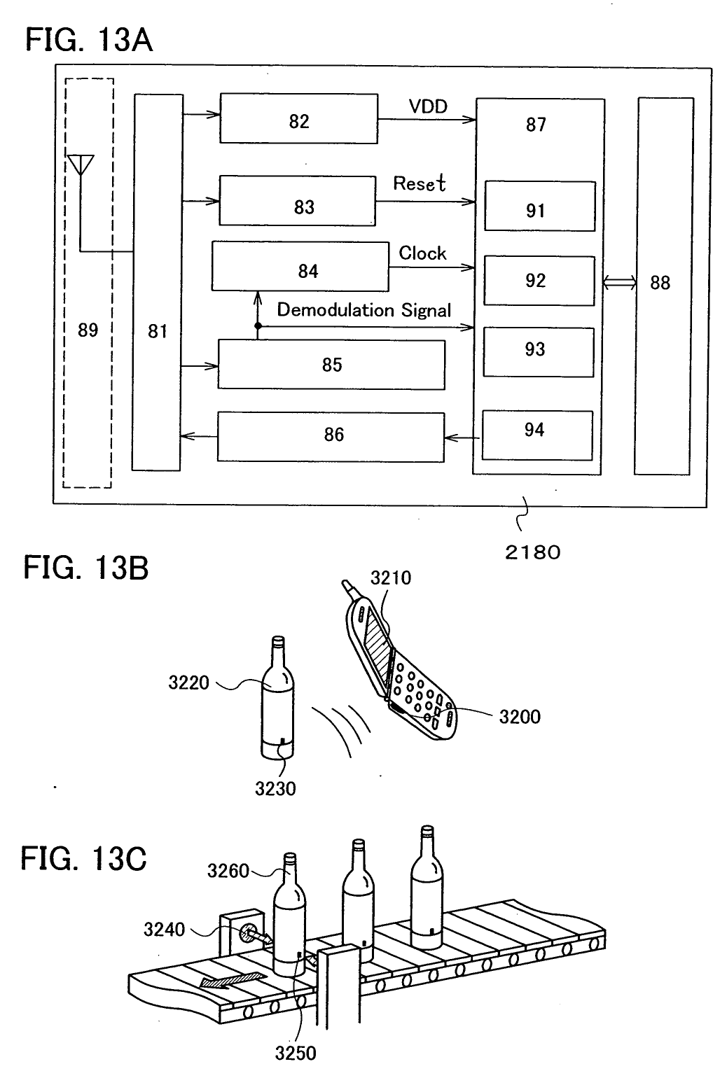

The semiconductor device 2180 functions to exchange data without contact, and includes a high frequency circuit 81, a power supply circuit 82, a reset circuit 83, a clock generation circuit 84, a data demodulation circuit 85, a data modulation circuit 86, a control circuit 87 for controlling other circuits, a memory circuit 88, and an antenna 89 (see FIG. 13A). The high frequency circuit 81 is a circuit which receives a signal from the antenna 89 and makes the antenna 89 output a signal received from the data modulation circuit 86. The power supply circuit 82 is a circuit which generates a power supply potential from the received signal. The reset circuit 83 is a circuit which generates a reset signal. The clock generation circuit 84 is a circuit which generates various clock signals based on the received signal that is input from the antenna 89. The data demodulation circuit 85 is a circuit which demodulates the received signal and outputs the signal to the control circuit 87. The data modulation circuit 86 is a circuit which modulates a signal received from the control circuit 87. As the control circuit 87, a code extraction circuit 91, a code determination circuit 92, a CRC determination circuit 93, and an output unit circuit 94 are formed, for example. Note that the code extraction circuit 91 is a circuit which individually extracts a plurality of codes included in an instruction transmitted to the control circuit 87. The code determination circuit 92 is a circuit which compares the extracted code and a reference code to determine the content of the instruction. The CRC determination circuit 93 is a circuit which detects the presence or absence of a transmission error or the like based on the determined code. In FIG. 13A, the semiconductor device 2180 also includes the high frequency circuit 81 and the power supply circuit 82 that are analog circuits, in addition to the control circuit 87.

Next, an example of operation of the above-described semiconductor device is described. First, a radio signal is received by the antenna 89. The radio signal is transmitted to the power supply circuit 82 via the high frequency circuit 81, and a high power supply potential (hereinafter referred to as VDD) is generated. The VDD is supplied to the circuits included in the semiconductor device 2180. In addition, a signal transmitted to the data demodulation circuit 85 via the high frequency circuit 81 is demodulated (hereinafter, a demodulated signal). Furthermore, the signal and the demodulated signal transmitted through the reset circuit 83 and the clock generation circuit 84 via the high frequency circuit 81 are transmitted to the control circuit 87. The signals transmitted to the control circuit 87 are decoded by the code extraction circuit 91, the code determination circuit 92, the CRC determination circuit 93, or the like. Then, in accordance with the decoded signals, information of the semiconductor device stored in the memory circuit 88 is output. The output information of the semiconductor device is encoded through the output unit circuit 94. Furthermore, the encoded information of the semiconductor device 2180 is, via the data modulation circuit 86, transmitted by the antenna 89 as a radio signal. Note that a low power supply potential (hereinafter, VSS) is common among a plurality of circuits included in the semiconductor device 2180, and VSS can be GND.

Thus, data of the semiconductor device 2180 can be read by transmission of a signal from a communication means (for example, a reader/writer or a means that has a function as either a reader or a writer) to the semiconductor device 2180 and receiving of the signal transmitted from the semiconductor device 2180 by the reader/writer.

In addition, the semiconductor device 2180 may supply a power supply voltage to each circuit by an electromagnetic wave without a power source (battery) mounted, or by an electromagnetic wave and a power source (battery) with the power source (battery) mounted.

Next, examples of application modes of the semiconductor device capable of inputting and outputting data without contact are described. A side surface of a portable terminal including a display portion 3210 is provided with a communication means 3200, and a side surface of an article 3220 is provided with a semiconductor device 3230 (see FIG. 13B). Note that the communication means 3200 is that which has functions of reading signals and transmitting signals like a reader/writer or that which has either of functions of reading signals and transmitting signals. When the communication means 3200 is held over the semiconductor device 3230 included in the article 3220, information about the article 3220 such as a raw material, the place of origin, an inspection result in each production step, the history of distribution, or an explanation of the article is displayed on the display portion 3210. Furthermore, when a product 3260 is transported by a conveyor belt, the product 3260 can be inspected using a communication means 3240 and a semiconductor device 3250 attached to the product 3260 (see FIG. 13C). As each of the semiconductor devices 3230 and 3250, the semiconductor device 2180 described above can be used. Thus, by utilizing the semiconductor device of the present invention in a system, information can be acquired easily, and improvement in performance and added value of the system can be achieved. The semiconductor device of the present invention has high reliability, and product inspection or the like can also be securely performed.

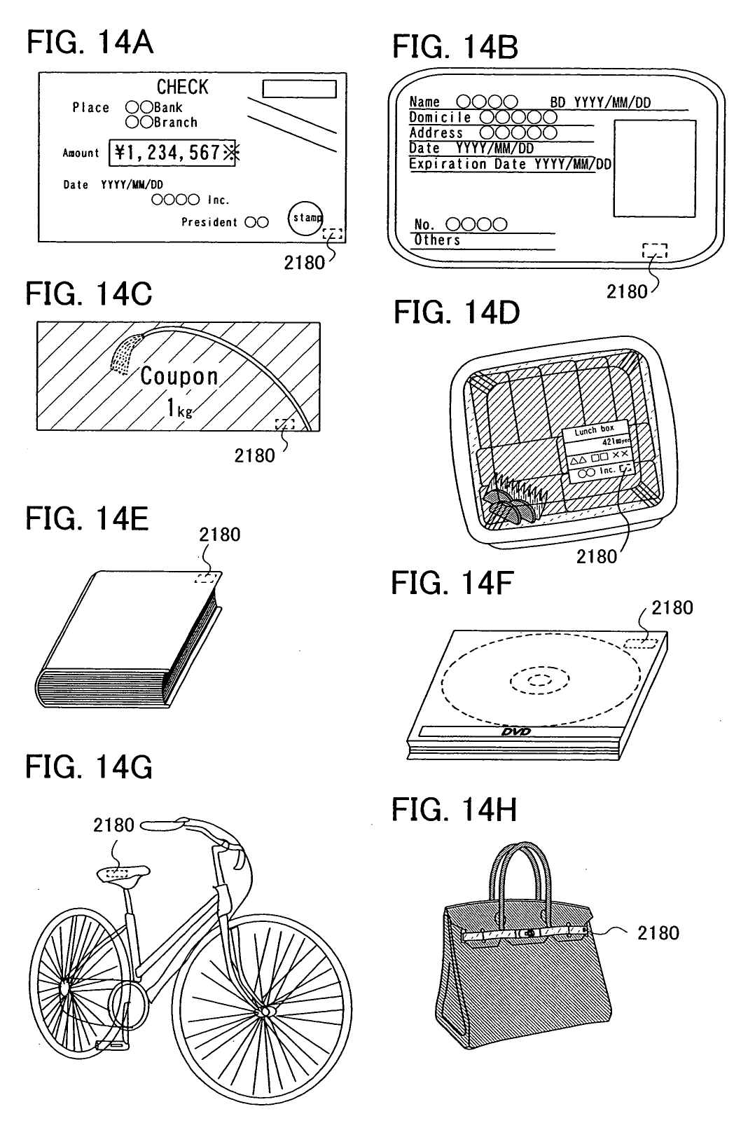

Note that the applicable range of the semiconductor device of the present invention is wide, without being limited to the above examples, and the semiconductor device can be applied to any product whose production, management, or the like can be supported by clarifying information such as the history of the product without contact. For example, the semiconductor device can be mounted on any of bills, coins, securities, certificates, bearer bonds, packing containers, books, recording media, personal belongings, vehicles, food, clothing, health products, commodities, medicines, electronic devices, and the like. Examples of these products are described with reference to FIGS. 14A to 14H.

Bills and coins are money distributed to the market and include one valid in a certain area (cash voucher), memorial coins, and the like. Securities refer to checks, promissory notes, and the like (see FIG. 14A). Certificates refer to driver's licenses, certificates of residence, and the like (see FIG. 14B). Bearer bonds refer to stamps, rice coupons, various gift certificates, and the like (see FIG. 14C). Packing containers refer to wrapping paper for food containers and the like, plastic bottles, and the like (see FIG. 14D). Books refer to hardbacks, paperbacks, and the like (see FIG. 14E). Recording media refer to DVD software, video tapes, and the like (see FIG. 14F). Vehicles refer to wheeled vehicles such as bicycles and the like, ships, and the like (see FIG. 14G). Personal belongings refer to bags, glasses, and the like (see FIG. 14H). Food refers to food articles, drink, and the like. Clothing refers to clothes, footwear, and the like. Health products refer to medical instruments, health instruments, and the like. Commodities refer to furniture, lighting equipment, and the like. Medicine refers to medical products, pesticides, and the like. Electronic devices refer to liquid crystal display devices, EL display devices, television devices (TV sets, flat-screen TV sets), cellular phones, and the like.

Forgery can be prevented by providing the semiconductor device 2180 to bills, coins, securities, certificates, bearer bonds, or the like. The efficiency of an inspection system, a system used in a rental shop, or the like can be improved by providing the semiconductor device 2180 to packing containers, books, recording media, personal belongings, food, commodities, electronic devices, or the like. Forgery or theft can be prevented by providing the semiconductor device 2180 to vehicles, health products, medicine, or the like; further, in the case of medicine, medicine can be prevented from being taken mistakenly. The semiconductor device 2180 is provided to such an article by being attached to the surface or being embedded therein. For example, in the case of a book, the semiconductor device 2180 may be embedded in a piece of paper; in the case of a package made from an organic resin, the semiconductor device 2180 may be embedded in the organic resin.

As described above, the efficiency of an inspection system, a system used in a rental shop, or the like can be improved by providing the semiconductor device to packing containers, recording media, personal belonging, food, clothing, commodities, electronic devices, or the like. In addition, by providing the semiconductor device to vehicles, forgery or theft can be prevented. Further, by implanting the semiconductor device in a creature such as an animal, an individual creature can be easily identified. For example, by implanting or providing the semiconductor device having a sensor in a creature such as livestock, its health condition such as a current body temperature as well as its birth year, sex, breed, or the like can be easily managed.

By application of the present invention, a TFT can be formed using a polycrystalline semiconductor film with fewer crystal defects and with a large gain size. In addition, due to favorable mobility and response speed, high-speed driving is possible, and the operation frequency of an element can be increased compared to a conventional element. This is because, by application of the present invention, crystal grains are elongated along a channel-length direction and the number of grain boundaries existing along the channel-length direction of a transistor becomes small. Note that the channel-length direction corresponds to a current flow direction, in other words, a direction in which charges are transferred in a channel formation region.

In performing laser crystallization, it is preferable that laser light be significantly narrowed. In the present invention, the shape of laser light is linear; thus, sufficient and efficient energy density for an irradiation object can be ensured. Note that the term “linear” used herein refers to not a line in a strict sense but a rectangle or an ellipse with a large aspect ratio, and a certain width may be ensured along a short-axis direction.

The laser irradiation apparatus of the present invention transfers intensity distribution of laser light along a long-axis direction due to the phase shift mask onto an irradiation surface using a cylindrical lens and a lens. Accordingly, a sufficient workspace can be made between the phase shift mask and the irradiation surface.

Note that this embodiment mode can be freely combined with any of the above embodiment modes.

### Embodiment 1

In this embodiment, a comparison of stability of intensity distribution of laser light is made between the case where a cylindrical lens and a spherical lens are used as an optical system which transfers light diffracted by a phase shift mask to an irradiation surface (hereinafter also referred to as a transfer optical system) in the laser irradiation apparatus of the present invention and the case where an aspheric cylindrical lens and an aspheric lens are used.

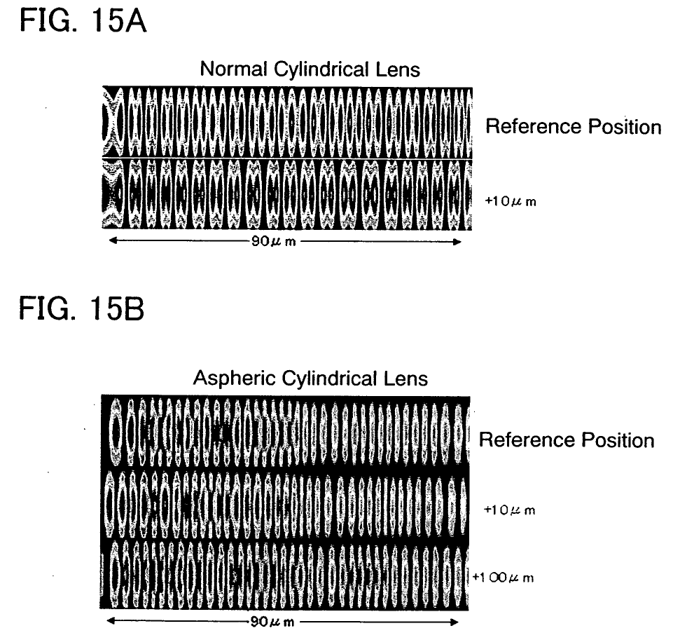

FIG. 15A shows intensity distribution of laser light along a long-axis direction which is transmitted through a phase shift mask at a reference position, a cylindrical lens, and a spherical lens, and intensity distribution of laser light along a long-axis direction, which is transmitted through the phase shift mask at a position 10 μm off the reference position, the cylindrical lens, and the spherical lens. For example, the reference position is a position where a distance between the phase shift mask and the cylindrical lens is equal to a focal length of the cylindrical lens. Then, “the position 10 μm off a reference position” means a position where a distance between the phase shift mask and the cylindrical lens is 10 μm longer than the focal length of the cylindrical lens. It can be seen from FIG. 15A that, in the case where a cylindrical lens and a spherical lens are used as the transfer optical system, intensity distribution of laser light is changed when the position of the phase shift mask is moved 10 μm from the reference position.

FIG. 15B shows intensity distribution of laser light along a long-axis direction which is transmitted through a phase shift mask at a reference position, an aspheric cylindrical lens, and an aspheric lens, and intensity distributions of laser light along a long-axis direction, which is transmitted through the phase shift mask at a position 10 μm or 100 μm off the reference position, the aspheric cylindrical lens, and the aspheric lens. For example, the reference position is a position where a distance between the phase shift mask and the aspheric cylindrical lens is equal to a focal length of the aspheric cylindrical lens. Then, “the position 10 μm or 100 μm off a reference position” means a position where a distance between the phase shift mask and the aspheric cylindrical lens is 10 μm or 100 μm longer than the focal length of the aspheric cylindrical lens. It can be seen from FIG. 15B that, in the case where an aspheric cylindrical lens and an aspheric lens are used as the transfer optical system, intensity distribution of laser light is stable even when the position of the phase shift mask is moved either 10 μm or 100 μm from the reference position.

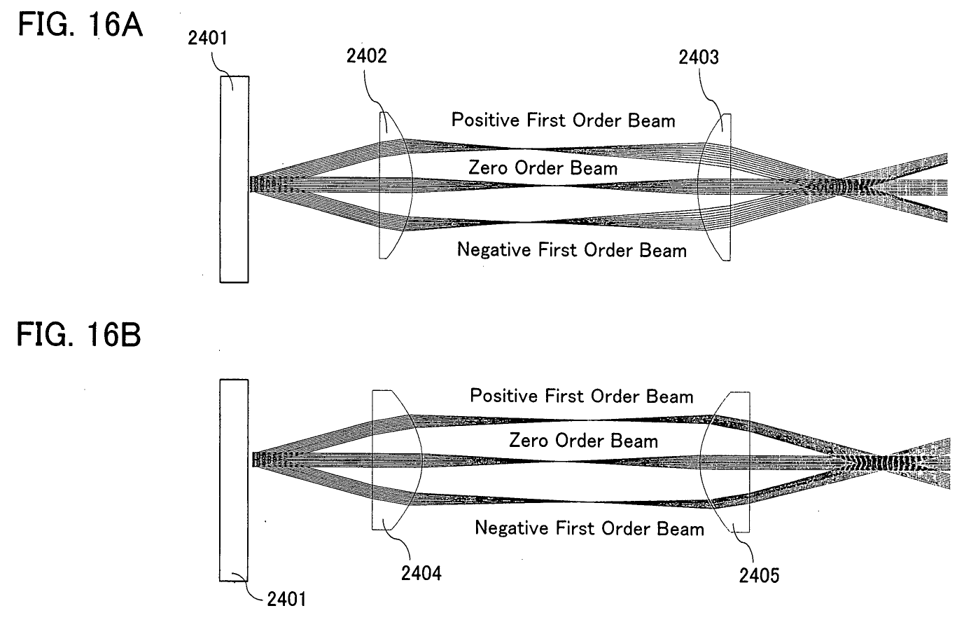

FIGS. 16A and 16B show calculation results of optical paths of laser light, which is transmitted through the phase shift mask, along a long-axis direction. FIG. 16A shows an optical path of laser light in the case where two spherical lenses are used as the transfer optical system, and FIG. 16B shows an optical path of laser light in the case where two aspheric lenses are used as the transfer optical system. Note that, for the calculation results, only a long-axis direction of laser light is considered and calculation is made on the assumption that the cylindrical lens of the transfer optical system is simply a spherical lens or an aspheric lens. In FIGS. 16A and 16B, the wavelength of laser light is 532 nm, the beam diameter is 2 mm, the pitch of a stripe pattern of a phase shift mask 2401 is 2 μm, and the angle of diffraction is 15.24°.

In FIG. 16A, the focal length f of each of spherical lenses 2402 and 2403 is 20 mm and the f-number is 1. The spherical lenses 2402 and 2403 are each formed of SF11 having a refractive index n of 1.785; the distance between the phase shift mask 2401 and the spherical lens 2402 is about 20 mm; and the distance between the spherical lens 2402 and the spherical lens 2403 is about 40 mm.

In the case where spherical lenses are used as the transfer optical system as shown in FIG. 16A, due to spherical aberration at the spherical lens 2402, the positive and negative first order beams, which are diffracted beams exiting from the phase shift mask 2401, are diverged compared to the zero order beam which propagates rectilinearly. Accordingly, on the irradiation surface, the positive and negative first order beams and the zero order beam are not focused at the same position. In addition, although not shown, the spherical lens 2403 converges light both in a long-axis direction and a short-axis direction at the same time. At this time, due to aberration of the spherical lens 2403, a difference is made between the position at which the laser light is converged along the long-axis direction and the position at which the laser light is converged along the short-axis direction.

In FIG. 16B, the focal length f of each of aspheric lenses 2404 and 2405 is 20 mm and the f-number is 0.95. The aspheric lenses 2404 and 2405 are each formed of B270 having a refractive index n of 1.523; the distance between the phase shift mask 2401 and the aspheric lens 2404 is about 20 mm; and the distance between the aspheric lens 2404 and the aspheric lens 2405 is about 40 mm.

As shown in FIG. 16B, in the case where aspheric lenses are used as the transfer optical system, spherical aberration can be suppressed. Therefore, light transmitted through the phase shift mask 2401 can be made to be incident on the irradiation surface in a collimated manner. Accordingly, even when the position of the phase shift mask 2401 is changed, defocus of laser light can be suppressed, and intensity distribution of laser light can be kept stable. In addition, aberration of the aspheric lens 2405 is suppressed; thus, a difference between the convergence position of laser light along a long-axis direction and the convergence position of the laser light along a short-axis direction can be suppressed.

By use of an aspheric cylindrical lens or an aspheric lens in the laser irradiation apparatus of the present invention, intensity distribution of laser light can be stabilized. By use of this laser irradiation apparatus for crystallization of an amorphous semiconductor film, a uniform melted state of the semiconductor film can be realized with laser light having uniform intensity distribution. Accordingly, generation of grain boundaries or defects such as twins within a crystallized semiconductor film can be suppressed.

### Embodiment 2

In this embodiment, intensity distributions of laser light when the phase shift mask is disposed parallel to a laser light scanning direction in the laser irradiation apparatus of the present invention and when disposed at a tilt of 20° (θ=20°) are described. Note that, in this embodiment, the pitch of the stripe pattern of the phase shift mask 103 is 2 μm.

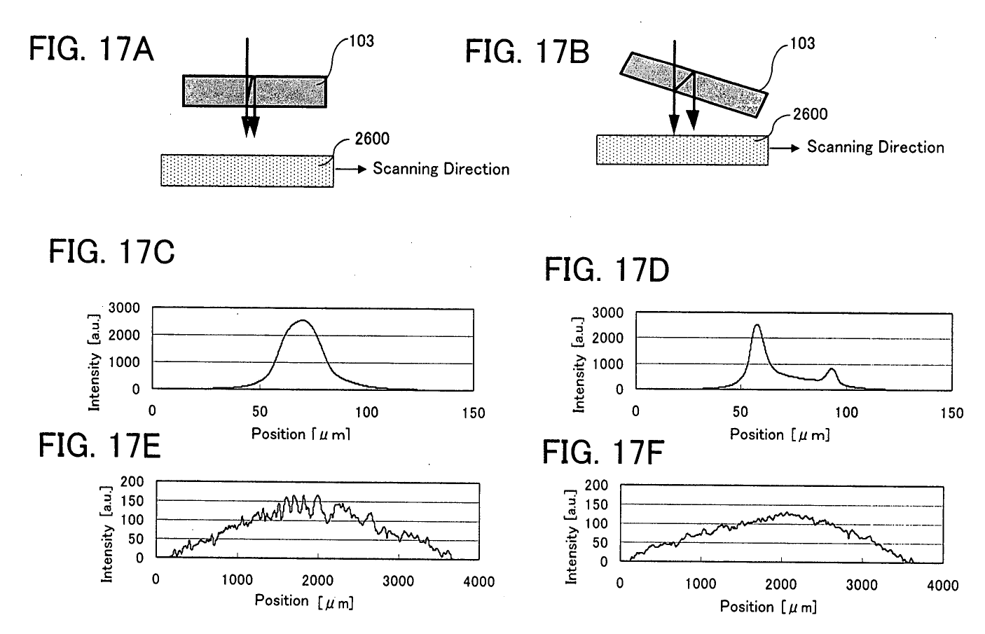

FIGS. 17A and 17B each show a schematic diagram of disposition of the phase shift mask in this embodiment. FIG. 17A shows a schematic diagram in which the phase shift mask 103 is disposed parallel to a scanning direction of a substrate 2600 (also referred to as a scanning direction with laser light). FIG. 17B shows a schematic diagram in which the phase shift mask 103 is disposed at a tilt of 20° to the scanning direction of the substrate 2600.

FIG. 17C shows intensity distribution of a beam spot along a short-axis direction (width direction) when scanning with laser light is performed with the disposition shown in FIG. 17A. FIG. 17E shows intensity distribution of a beam spot along a long-axis direction (length direction) when scanning with laser light is performed with the disposition shown in FIG. 17A. In each of FIGS. 17C and 17E, the vertical axis represents the intensity (a.u.) of laser light and the horizontal axis represents the position (μm) in the beam spot.

As shown in FIGS. 17C and 17E, when the phase shift mask 103 is disposed parallel to the laser light scanning direction, the intensity distribution of laser light has one maximum point along the short-axis direction. However, along the long-axis direction, the intensity distribution of laser light is not at a pitch of 2 μm which corresponds to the pitch of the stripe pattern of the phase shift mask 103, and periodic changes at longer intervals are observed. It can be considered that the changes are caused because the laser light interferes at the front face and the rear face of the phase shift mask 103.

FIG. 17D shows intensity distribution of a beam spot along a short-axis direction (width direction) when scanning with laser light is performed with the disposition shown in FIG. 17B. FIG. 17F shows intensity distribution of a beam spot along a long-axis direction (length direction) when scanning with laser light is performed with the disposition shown in FIG. 17B. In each of FIGS. 17D and 17F, the vertical axis represents the intensity (a.u.) of laser light and the horizontal axis represents the position (μm) in the beam spot.

As shown in FIG. 17F, when the phase shift mask 103 is disposed at a tilt of 20° to the laser light scanning direction, there are no periodic changes as seen in FIG. 17E, and a beam spot having a Gaussian distribution along a long-axis direction can be formed as a whole. Although not shown, this beam spot has intensity distribution, along the long-axis direction, which is dependent on the pitch of the stripe pattern of the phase shift mask 103.

In addition, as shown in FIG. 17D, the intensity distribution has two maximum points along the short-axis direction. As described above, a beam spot having two maximum points causes variations of laser light along a short-axis direction. In this embodiment, the width of the beam spot is 5 μm to 10 μm and it can be seen from FIG. 17D that the distance between the two maximum points is about 30 μm. Therefore, the two maximum points are not in the same beam spot, and laser light without any variations along the short-axis direction as well can be obtained. Note that, in this embodiment, the thickness d of the phase shift mask 103 is 0.7 mm, and quartz is used as a material of the phase shift mask, which has a refractive index n of 1.486. Accordingly, when θ is 20°, the aforementioned expression, φ<4d·tan θ′·cos θ, is satisfied.

As described above, by tilting of the phase shift mask at an angle θ (degrees) to the laser light scanning direction in the laser irradiation apparatus of the present invention, the effect of interference that occurs at the front face and the rear face of the phase shift mask can be suppressed, and laser light in which variations of intensity distribution other than at desired periods are reduced along the long-axis direction of the beam spot can be obtained. Note that, when the phase shift mask is disposed at a tilt angle θ (degrees) to the laser light scanning direction, two maximum points are generated along the short-axis direction; thus, it is preferable that the scanning direction be unidirectional.

### Embodiment 3

In this embodiment, the influence on crystallization of a difference in the number of times an amorphous semiconductor film is irradiated in crystallization using the laser irradiation apparatus of the present invention is described.

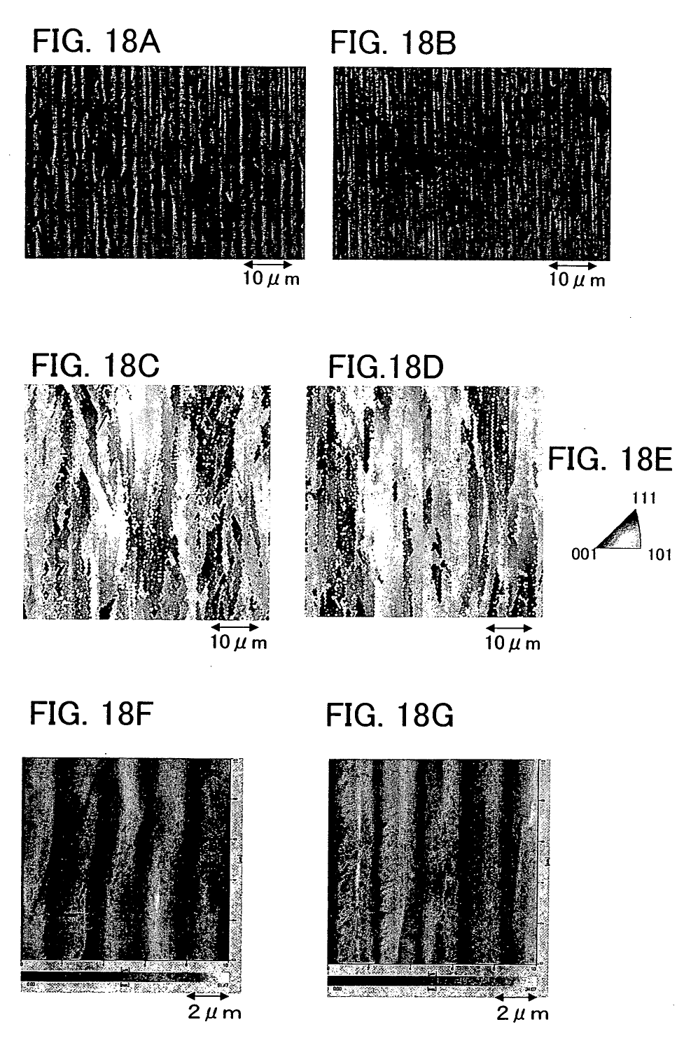

FIGS. 18A and 18B show optical micrographs of a crystalline semiconductor film which is manufactured using the laser irradiation apparatus of the present invention. A sample of this embodiment was manufactured by the process described below. First, a silicon oxynitride film having a thickness of 50 nm and a silicon nitride oxide film having a thickness of 150 nm were formed as a base insulating film over a glass substrate, and an amorphous silicon film having a thickness of 66 nm was then formed. Next, the amorphous silicon film was irradiated with laser light using the laser irradiation apparatus of the present invention. In this embodiment, the energy of the laser light was 16.5 W and the scanning rate was 200 mm/sec. In addition, in the laser irradiation apparatus, the pitch of the stripe pattern of the phase shift mask was 2 μm. Note that FIG. 18A is an optical micrograph of a crystalline semiconductor film which has been irradiated with laser light once. FIG. 18B is an optical micrograph of a crystalline semiconductor film which has been irradiated with laser light once and then irradiated again with laser light at the same position.

As shown in FIG. 18A, in the crystalline semiconductor film which has been irradiated with laser light once, random grain boundaries are formed in a plurality of crystal zones formed in the crystalline semiconductor film. However, it can be seen as shown in FIG. 18B that, in the crystalline semiconductor film which has been irradiated with laser light twice, the direction of crystal growth of the crystalline semiconductor film is uniform and crystallinity is improved compared to the crystalline semiconductor film which has been irradiated with laser light once.

In addition, electron backscatter diffraction pattern (EBSP) measurement was performed to check the position, size, and plane orientation of crystal grains of the crystalline semiconductor film which has been irradiated with laser light once and those of the crystalline semiconductor film which has been irradiated with laser light twice. EBSP refers to a method by which an orientation of a diffraction image (an EBSP image) of individual crystal, which is generated when a sample highly tilted in a scanning electron microscope connected to an EBSP detector is irradiated with a convergent electron beam, is analyzed, and the plane orientation of crystal grains of the sample is measured from orientation data and positional information of a measurement point (x, y). FIGS. 18C and 18D show the results.

FIG. 18C shows plane orientation distribution in the crystalline semiconductor film which has been irradiated with laser light once; FIG. 18D shows plane orientation distribution in the crystalline semiconductor film which has been irradiated with laser light twice; and FIG. 18E shows plane orientation in FIGS. 18C and 18D.

The measurement area by EBSP measurement is 50 μm×50 μm. Comparing FIGS. 18C and 18D, a certain level of orientation of crystal grains can be observed in FIG. 18C where laser irradiation has been performed once; however, there are also crystal grains grown in irregular directions. On the other hand, in FIG. 18D where laser irradiation has been performed twice for crystallization, a plurality of long crystal grain regions occupies a large area, and it can be confirmed that crystallinity is improved compared to the case where laser irradiation has been performed once. In addition, in FIG. 18D, long-axis directions of crystal grains are roughly oriented in one direction, and the size of large-grain crystals in the crystalline semiconductor film is about 20 μm to 50 μm along a long-axis direction. It can be confirmed that, by irradiation with laser light a plurality of times, the size of crystals is increased as compared to the case where laser irradiation is performed once, and crystal grain boundaries (boundaries of crystal zones) extended along the long-axis direction of crystals are oriented in one direction.

Furthermore, in order to measure the surface shape of the quasi-single crystal silicon of the present invention, the measurement was performed using an atomic force microscope (AFM). With the AFM, force acting between the surface of a solid sample and a probe is observed as detectable physical quantity. FIG. 18F shows a three-dimensional representation of an AFM measurement image of the crystalline semiconductor film which has been irradiated with laser light once, and FIG. 18G shows a three-dimensional representation of an AFM measurement image of the crystalline semiconductor film which has been irradiated with laser light twice.

As shown in FIG. 18F, the crystalline semiconductor film which has been irradiated with laser light once has a portion in which the periodicity of surface unevenness is irregular. However, as shown in FIG. 18G, in the crystalline semiconductor film which has been irradiated with laser light twice, the periodicity of surface unevenness is regular and grain boundaries are formed with higher precision.

By irradiation with laser light a plurality of times, grain boundaries in crystal zones formed by the first laser irradiation are recrystallized and growth is accelerated in the crystal zones. Therefore, the positions at which crystal grains are generated can be controlled with higher precision. Accordingly, in the case where an amorphous semiconductor film is crystallized using the laser irradiation apparatus of the present invention, crystallinity can be further improved by irradiation with laser light once and then irradiation again at the same position.

### Embodiment 4

In this embodiment, a crystalline semiconductor film which is manufactured using a laser irradiation apparatus of the present invention having a slit is described.

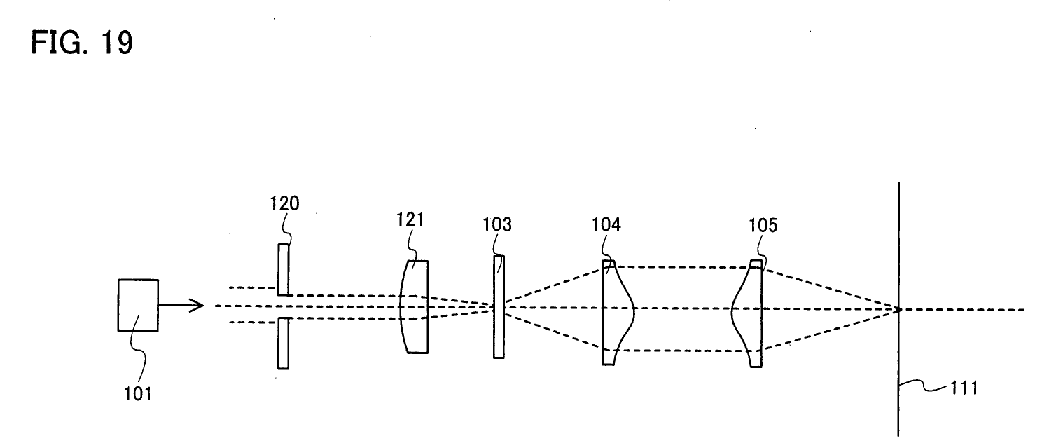

FIG. 19 shows a structure of an optical system of the laser irradiation apparatus of this embodiment. The laser irradiation apparatus of this embodiment has a slit 120 and a lens, which transfers an image obtained through the slit 120 to the phase shift mask 103, between the laser 101 and the phase shift mask 103. In this embodiment, a cylindrical lens 121 is provided as the lens which transfers an image obtained through the slit 120 to the phase shift mask 103, but the present invention is not limited to this structure, and another lens may be used. In this embodiment, laser light emitted from the laser 101 passes through the slit 120, whereby portions at both ends where energy density is low are cut off. The image obtained through the slit 120 is transferred to the phase shift mask 103 by the cylindrical lens 121 and shaped into a linear beam spot having intensity distribution along a long-axis direction by the phase shift mask 103, the cylindrical lens 104, and the lens 105. After that, the irradiation surface 111 is irradiated therewith. Note that, in this embodiment, the pitch of the stripe pattern of the phase shift mask 103 is 2 μm. In addition, in this embodiment, each of the cylindrical lens 104 and the lens 105 is an aspheric lens. However, the present invention is not limited to this structure, and one or both of the cylindrical lens 104 and the lens 105 may be a spherical lens.

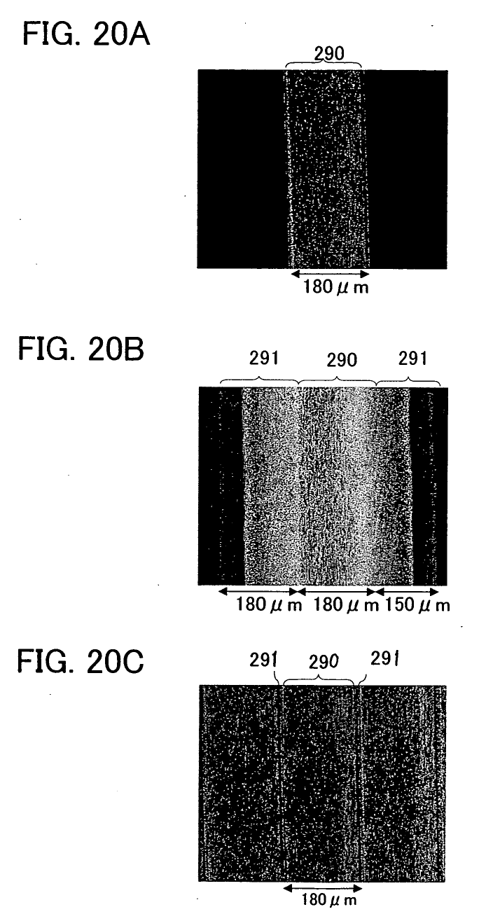

FIG. 20A shows an optical micrograph of a sample in which an amorphous semiconductor film is scanned with laser light once with the use of the laser irradiation apparatus of this embodiment. The sample shown in FIG. 20A was manufactured by the process described below. First, a silicon oxynitride film having a thickness of 50 nm and a silicon nitride oxide film having a thickness of 100 nm were formed as a base insulating film over a glass substrate, and then, an amorphous silicon film was formed to a thickness of 66 nm. Next, the amorphous silicon film was irradiated with laser light with the use of the laser irradiation apparatus of this embodiment. FIG. 20B shows, for comparison, an optical micrograph of a sample in which an amorphous semiconductor film formed by the same manufacturing method as FIG. 20A is scanned with laser light once with the use of the laser irradiation apparatus of the present invention having the structure shown in FIG. 1 without any slit provided. In this embodiment, irradiation was performed with a linear beam spot having a length of 250 μm and a width of 5 μm to 10 μm and having an energy of 16.5 W at a scanning rate of 200 mm/sec. In FIG. 20B, the pitch of the stripe pattern of the phase shift mask of the laser irradiation apparatus was 2 μm similar to FIG. 20A.

As shown in FIG. 20B, by use of the laser irradiation apparatus shown in FIG. 1, a crystallized region 290 having a width of about 180 μm and having a grain boundary at a controlled position can be formed. However, energy distribution along a length direction in the linear beam spot used for irradiation is a Gaussian distribution. Therefore, there are defective crystallized regions 291 of about 150 μm to 180 μm in portions at both ends where energy density is low. On the other hand, when the laser irradiation apparatus of this embodiment is used, portions where energy density is low are cut off by the slit 120. Therefore, the crystallized region 290 having a width of about 180 μm can be formed with less loss in energy of laser light.

FIG. 20C shows an optical micrograph of a sample in which an amorphous semiconductor film manufactured over a substrate similar to FIG. 20A is entirely scanned with laser light with the use of the laser irradiation apparatus of this embodiment. As shown in FIG. 20C, by continuous irradiation using the laser irradiation apparatus of this embodiment, a plurality of crystallized regions 290 each having a width of about 180 μm can be formed over the entire substrate. In addition, the width of each defective crystallized region 291 formed between the crystallized regions 290 can be decreased to about 25 μm or less.

As described above, with the laser irradiation apparatus having the structure described in this embodiment, an image obtained through the slit and light diffracted by the phase shift mask can be transferred to an irradiation surface at the same time, and a region of laser light having low energy density can be blocked with the slit. By use of the laser irradiation apparatus of the present invention having a slit as described above for crystallization, loss in energy of laser light at the irradiation surface can be reduced, and a defective crystallized region of a crystallized semiconductor film can be decreased.

### Embodiment 5

In this embodiment, measurement results of characteristics of a crystalline semiconductor film which is obtained by crystallization of an amorphous semiconductor film through a cap film as described in Embodiment Mode 2 are described. Note that a sample of this embodiment was manufactured by the process described below. First, a silicon oxynitride film having a thickness of 50 nm and a silicon nitride oxide film having a thickness of 100 nm were formed as a base insulating film over a glass substrate, and then, an amorphous silicon film was formed to a thickness of 66 nm. Next, a silicon nitride oxide film was formed to a thickness of 500 nm as a cap film, and the amorphous silicon film was irradiated with laser light from above the cap film with the use of the laser irradiation apparatus of the present invention. In this embodiment, irradiation was performed once with laser light having an energy of 16.5 W at a scanning rate of 200 mm/sec. In addition, the pitch of the stripe pattern of the phase shift mask of the laser irradiation apparatus was 2 μm.

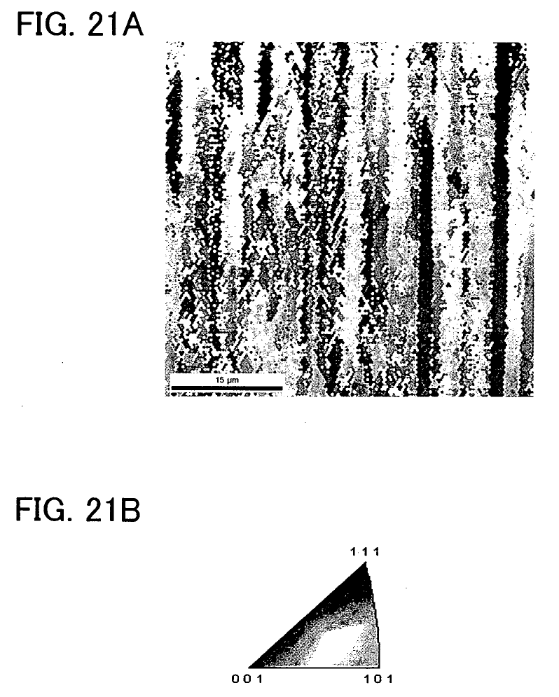

FIG. 21A shows results of EBSP measurement of the crystalline semiconductor film manufactured. FIG. 21B shows plane orientation of FIG. 21A. The measurement area by EBSP measurement is 50 μm×50 μm. It can be seen from FIG. 21A that, in the crystalline semiconductor film manufactured by the laser irradiation method of the present invention through the cap film, a plurality of long crystal grain regions occupies a large area, and long-axis directions of the crystal grains are roughly oriented in one direction. By crystallization performed through a cap film in this manner, a crystalline semiconductor film in which crystal grain boundaries (boundaries between crystal zones) extended along a long-axis direction of crystals are oriented in one direction can be obtained. As a result of observation of crystal orientation in each crystal zone, it is confirmed that variations of orientation along a crystal growth direction are suppressed as compared to the case where the cap film is not used.

In addition, as a result of measurement, using an AFM, of surface unevenness of the crystalline semiconductor film manufactured in this embodiment, it is confirmed that the surface roughness is 0.6 nm and sufficient planarity can be ensured. For comparison, an amorphous semiconductor film was formed by a similar manufacturing process and crystallized by a similar laser irradiation method without any cap film. The surface roughness of the crystalline semiconductor film manufactured was 7.3 nm.

As described above, in crystallization of an amorphous semiconductor film by the laser irradiation method of the present invention, a cap film is formed over the amorphous semiconductor film and the amorphous semiconductor film is crystallized through the cap film, whereby a crystalline semiconductor film in which crystal grain boundaries (boundaries between crystal zones) extended along a long-axis direction of crystals are oriented in one direction can be obtained. In addition, the crystalline semiconductor film manufactured has planarity, and variations of orientation along a crystal growth direction are reduced.

This application is based on Japanese Patent Application serial no. 2007-212046 filed with Japan Patent Office on Aug. 16, 2007, the entire contents of which are hereby incorporated by reference.

What is claimed is:

1. A laser irradiation apparatus comprising:
a laser configured to emit a pulsed laser light having a repetition rate of 10 MHz or more or a laser configured to emit a continuous-wave laser light;
a phase shift mask configured to diffract laser light emitted from the laser to change intensity distribution along a long-axis direction;
a cylindrical lens configured to form an image of the laser light diffracted by the phase shift mask on an irradiation surface; and
a lens configured to converge the laser light diffracted by the phase shift mask on the irradiation surface.

2. A laser irradiation apparatus comprising:
a laser configured to emit a pulsed laser light having a repetition rate of 10 MHz or more or a laser configured to emit a continuous-wave laser light;
a phase shift mask configured to diffract laser light emitted from the laser to change intensity distribution along a long-axis direction;
an aspheric cylindrical lens configured to form an image of the laser light diffracted by the phase shift mask on an irradiation surface; and
a lens configured to converge the laser light diffracted by the phase shift mask on the irradiation surface.

3. A laser irradiation apparatus comprising:
a laser configured to emit a pulsed laser light having a repetition rate of 10 MHz or more or a laser configured to emit a continuous-wave laser light;
a phase shift mask configured to diffract laser light emitted from the laser to change intensity distribution along a long-axis direction;
a cylindrical lens configured to form an image of the laser light diffracted by the phase shift mask on an irradiation surface; and
an aspheric lens configured to converge the laser light diffracted by the phase shift mask on the irradiation surface.

4. A laser irradiation apparatus comprising:
a laser configured to emit a pulsed laser light having a repetition rate of 10 MHz or more or a laser configured to emit a continuous-wave laser light;
a phase shift mask configured to diffract laser light emitted from the laser to change intensity distribution along a long-axis direction;
an aspheric cylindrical lens configured to form an image of the laser light diffracted by the phase shift mask on an irradiation surface; and
an aspheric lens configured to converge the laser light diffracted by the phase shift mask on the irradiation surface.

5. The laser irradiation apparatus according to claim 1, further comprising a slit for blocking an end portion of the laser light emitted from the laser between the laser and the phase shift mask.

6. The laser irradiation apparatus according to claim 2, further comprising a slit for blocking an end portion of the laser light emitted from the laser between the laser and the phase shift mask.

7. The laser irradiation apparatus according to claim 3, further comprising a slit for blocking an end portion of the laser light emitted from the laser between the laser and the phase shift mask.

8. The laser irradiation apparatus according to claim 4, further comprising a slit for blocking an end portion of the laser light emitted from the laser between the laser and the phase shift mask.

9. The laser irradiation apparatus according to claim 1,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

10. The laser irradiation apparatus according to claim 2,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

11. The laser irradiation apparatus according to claim 3,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

12. The laser irradiation apparatus according to claim 4,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

13. A laser irradiation method comprising the steps of:
modulating laser light emitted from a laser configured to emit a pulsed laser light having a repetition rate of 10 MHz or more or from a laser configured to emit a continuous-wave laser light into laser light having intensity distribution along a long-axis direction through a phase shift mask; and
irradiating an irradiation surface with the laser light transmitted through the phase shift mask through a cylindrical lens and a lens.

14. A laser irradiation method comprising the steps of:
modulating laser light emitted from a laser configured to emit a pulsed laser light having a repetition rate of 10 MHz or more or from a laser configured to emit a continuous-wave laser light into laser light having intensity distribution along a long-axis direction through a phase shift mask; and
irradiating an irradiation surface with the laser light transmitted through the phase shift mask through an aspheric cylindrical lens and a lens.

15. A laser irradiation method comprising the steps of:
modulating laser light emitted from a laser configured to emit a pulsed laser light having a repetition rate of 10 MHz or more or from a laser configured to emit a continuous-wave laser light into laser light having intensity distribution along a long-axis direction through a phase shift mask; and
irradiating an irradiation surface with the laser light transmitted through the phase shift mask through a cylindrical lens and an aspheric lens.

16. A laser irradiation method comprising the steps of:
modulating laser light emitted from a laser configured to emit a pulsed laser light having a repetition rate of 10 MHz or more or from a laser configured to emit a continuous-wave laser light into laser light having intensity distribution along a long-axis direction through a phase shift mask; and
irradiating an irradiation surface with the laser light transmitted through the phase shift mask through an aspheric cylindrical lens and an aspheric lens.

17. The laser irradiation method according to claim 13,
wherein the laser light emitted from the laser is incident on a slit to block an end portion of the laser light, and
wherein the laser light transmitted through the slit is incident on the phase shift mask.

18. The laser irradiation method according to claim 14,
wherein the laser light emitted from the laser is incident on a slit to block an end portion of the laser light, and
wherein the laser light transmitted through the slit is incident on the phase shift mask.

19. The laser irradiation method according to claim 15,
wherein the laser light emitted from the laser is incident on a slit to block an end portion of the laser light, and
wherein the laser light transmitted through the slit is incident on the phase shift mask.

20. The laser irradiation method according to claim 16,
wherein the laser light emitted from the laser is incident on a slit to block an end portion of the laser light, and
wherein the laser light transmitted through the slit is incident on the phase shift mask.

21. The laser irradiation method according to claim 13,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

22. The laser irradiation method according to claim 14,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

23. The laser irradiation method according to claim 15,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

24. The laser irradiation method according to claim 16,
wherein the phase shift mask is disposed at a tilt angle θ to a laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

25. The laser irradiation method according to claim 13, wherein the laser light transmitted through the phase shift mask has a plurality of periodic intensity peaks along a long-axis direction.

26. The laser irradiation method according to claim 14, wherein the laser light transmitted through the phase shift mask has a plurality of periodic intensity peaks along a long-axis direction.

27. The laser irradiation method according to claim 15, wherein the laser light transmitted through the phase shift mask has a plurality of periodic intensity peaks along a long-axis direction.

28. The laser irradiation method according to claim 16, wherein the laser light transmitted through the phase shift mask has a plurality of periodic intensity peaks along a long-axis direction.

29. A manufacturing method of a semiconductor device, comprising the steps of:
modulating laser light emitted from a laser configured to emit a pulsed laser light having a repetition rate of 10 MHz or more or from a laser configured to emit a continuous-wave laser light and made incident on a phase shift mask into laser light having intensity distribution along a long-axis direction;
crystallizing an amorphous semiconductor film provided over an insulating substrate by irradiating the amorphous semiconductor film with the laser light transmitted through the phase shift mask through a cylindrical lens and a lens while scanning the amorphous semiconductor film with the laser light in a perpendicular direction to the long-axis direction of the laser light.

30. A manufacturing method of a semiconductor device, comprising the steps of:
modulating laser light emitted from a laser configured to emit a pulsed laser light having a repetition rate of 10 MHz or more or from a laser configured to emit a continuous-wave laser light and made incident on a phase shift mask into laser light having intensity distribution along a long-axis direction;
crystallizing an amorphous semiconductor film provided over an insulating substrate by irradiating a cap film provided over the amorphous semiconductor film with the laser light transmitted through the phase shift mask through a cylindrical lens and a lens while scanning the amorphous semiconductor film with the laser light in a perpendicular direction to the long-axis direction of the laser light.

31. The manufacturing method of a semiconductor device according to claim 29, wherein an element which accelerates crystallization is used for the crystallization.

32. The manufacturing method of a semiconductor device according to claim 30, wherein an element which accelerates crystallization is used for the crystallization.

33. The manufacturing method of a semiconductor device according to claim 29, wherein the laser light emitted from the laser is incident on the phase shift mask after passing through a slit.

34. The manufacturing method of a semiconductor device according to claim 30, wherein the laser light emitted from the laser is incident on the phase shift mask after passing through a slit.

35. The manufacturing method of a semiconductor device according to claim 29, wherein the cylindrical lens is an aspheric cylindrical lens.

36. The manufacturing method of a semiconductor device according to claim 30, wherein the cylindrical lens is an aspheric cylindrical lens.

37. The manufacturing method of a semiconductor device according to claim 29, wherein the lens is an aspheric lens.

38. The manufacturing method of a semiconductor device according to claim 30, wherein the lens is an aspheric lens.

39. The manufacturing method of a semiconductor device according to claim 29,
wherein the phase shift mask is disposed at a tilt angle θ to the laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.

40. The manufacturing method of a semiconductor device according to claim 30,
wherein the phase shift mask is disposed at a tilt angle θ to the laser light scanning direction, and
wherein the tilt angle θ satisfies φ<4d·tan θ′·cos θ, where φ is a width of a beam spot on the irradiation surface, d is a thickness of the phase shift mask, and θ′ is an angle of refraction of the laser light incident on the phase shift mask.
